(19) United States
(12) Patent Application Publication
(10) Pub. No.: US 2017/0108894 A1
(43) Pub. Date: Apr. 20, 2017

(54) Device Encasement System with enhancing features

(71) Applicant: Ixtra Tech, Inc., Santa Clara, CA (US)

(72) Inventor: Adel George Tannous, Santa Clara, CA (US)

(21) Appl. No.: 14/975,886

(22) Filed: Dec. 21, 2015

Related U.S. Application Data
(60) Provisional application No. 62/243,650, filed on Oct. 19, 2015.

(51) Int. Cl. G06F 1/16; A45F 5/00; H04L 29/08; H04B 1/3883; G06F 9/445; A45C 11/00; H04B 1/3888

(52) U.S. Cl. CPC G06F 1/1628; A45C 11/00; A45F 5/00; H04B 1/3888; H04B 1/3883; G06F 1/1658; G06F 8/61; H04L 67/34; A45C 2011/002; A45C 2011/003

(57) ABSTRACT

This disclosure relates generally to mobile devices. Specifically the device relates to cases, protective cases and supplemental feature cases for mobile devices. In one example embodiment methods, apparatus and systems are described to encase a mobile device, to protect the mobile device, as well as add supplemental features such as additional memory including long term memory storage and short term memory storage, processing, additional buses, additional power or data ports, power storage including additional batteries and system power, sensors, emitters, communication ports or slots, communication antennas and radios, wireless power charging and transfer capability memory, expandable feature ports or slots, firmware and software, as well as and other features. In one example embodiment, the encasement system provides supplemental and enhancing features to a mobile device, in addition to encasement protection.

### FIELD OF TECHNOLOGY

This disclosure relates generally to mobile devices. Specifically the device relates to cases, protective cases and supplemental feature cases for mobile devices. In one example embodiment methods, apparatus and systems are described to encase a mobile device, to protect the mobile device, as well as add supplemental features such as additional memory including long term memory storage and short term memory storage, processing, additional buses, additional power or data ports, power storage including additional batteries and system power, sensors, emitters, communication ports or slots, communication antennas and radios, wireless power charging and transfer capability memory, expandable feature ports or slots, firmware and software, as well as and other features. In one example embodiment, the encasement system provides supplemental and enhancing features to a mobile device, in addition to encasement protection.

### BACKGROUND

Within many fields, notably within the electronic device and specifically mobile device fields, devices are, due to their nature, inevitably delicate and easily breakable. Because of the small and mobile characteristics of the devices, and of the need to be handheld or otherwise disconnectedly handled by the user, the devices are inevitably dropped, roughhoused, pressured, squished, sat upon or otherwise stressed or exerted to undesirable forces including shock forces and other forces which may be undesirable. Additionally, the devices may be exposed to elements and materials such as dust, harming materials such as sand, water, liquids, and other materials which may damage or hamper the device from being usable. These undesirable forces may crack the screen, scratch the screen, damage or short internal or external electronic components, crack the external facade or break or damage the device in numerous ways. It has then become popular to encase devices with a plastic, composite, metal or other type of case, which may provide protection from the above undesirable forces and elements. Alongside this, in today's mobile device market, devices have become smaller and more powerful and as such, memory storage, battery life, and features such as sensors, have become limited. Many consumers wish for higher battery capacity, more memory, or other features than what is offered from the manufactures. As such, add-on's either in memory cards or expanded power packs, or other devices are popular. A need then for additional supplemental features and also casing is apparent. The cases sold in today's market, provide different levels of protection, however, as is the nature of encasing an object, the device becomes bulkier, heftier or otherwise larger than it was before. With this, the case is largely wasted space, and while the bulk is necessary to protect the encased device, it can be seen that the space may be used to fulfill other purposes of which the consumers have necessitated, while simultaneously providing the same protection for the encased device.

In addition, many device manufactures limit the accessible internal API and OS functionalities, and as such proprietary or third party software and workarounds must be enlisted to overcome the limitations placed by the device manufacturers.

In addition, some mobile devices have limited memory that cannot be extended. But because mobile devices are used for many purposes, in addition to telecommunication, they oftentimes run out of memory; limiting their capabilities. Moreover, with the advancement of electronics, there are many sensors and computer chips that can be used to enhance the capabilities of mobile devices. However, in order to take advantage of the existing hardware in enhancing mobile devices capabilities, software and hardware needs to be designed and developed to act as a fully integrated extension of the device intelligence. The additional intelligence and capabilities would require additional memory for all data storage and processing.

### SUMMARY

Disclosed are methods, apparatus, and systems that provide an encasement for mobile devices. The encasement may provide numerous features beyond those provided by a traditional case which provides solely provides protection to the encased device. The present invention may provide a physical barrier to protect or otherwise isolate the mobile device from the outside environment or outside forces. The forces may be shock or pressure from dropping the device, handling the device, squishing the device or otherwise exerting a forces or force that would otherwise break the device. The case may also isolate the encased device from outside elements and materials such as dust, sand, water or liquid. The case, inherently provides a larger ability to withstand such forces, both in its own structure to not damage or break and also stops the force or loads from inflicting damage on the encased device through any method such as distributing the force over a larger area or by providing a more resistant structure. Also, the case may provide isolation, semi-isolation and/or protection from outside elements such as liquids, dust, temperature, UV exposure, or other types of environments, elements or substances which may be detrimental to the device's ability to function properly. The case may provide different levels of protection depending on the embodiment as necessitated by the intended use. The levels of protection for example may range from full waterproofing and immersion capabilities, or simply splash protection while also providing other protection such as protection from shock or protection from dust. These capabilities may be measured in standardized tests and ratings by any organization such as MIL-STD, IP, NEMA, or other standards which can certify a device or provide information on what the case protects from. The encasement also, in its preferred embodiments, may provide further features than just protection. The case may be impregnated or be assembled with structures and abilities for further features to supplement the device in a multitude of aspects. These supplemental features may be seen as intelligent features or features that provide additional capabilities to the device's current system. These features or structures may include additional processors, memory, local peripherals, expansion buses, power transfer apparatuses, hardware hubs, batteries, antennas, communication devices, displays, card other memory expansion slots or ports, additional connection ports, speakers, random number generators, LEDs such as status indicators, wireless charging, inductive charging or other types of charging, additional software or logic processes performed on or in the case itself, and any and all further feature one skilled in the art would reasonably find useful to provide within or on the encasement to supplement the case's design and use, and also the encased device.

In addition, software, such as an app, may be implemented, installed or otherwise run as an extension of present invention. The software may be run within the case or within the encased device as to provide a service to the case or encased device, such as to allow the case to interact, capture, or receive data from the encased device or hardware or software in the encased device such as a camera.

### BRIEF DESCRIPTION OF THE DRAWINGS

FIGS 1a and 1b are frontal views showing embodiments of the case.

FIGS. 2a and 2b are behind views showing embodiments of the case.

FIGS. 3a and 3b are top and bottom views of embodiments of the case and 3c is a side view of an embodiment of the case.

FIGS. 4a and 4b are frontal views of embodiments of the case with cutouts demonstrating internal details.

FIGS. 5a and 5b are behind views showing embodiments of the case with cutouts demonstrating internal details.

FIGS. 6a, 6b and 6c are side views showing embodiments of the case with cutouts demonstrating internal details

FIG. 7 is a side view showing an embodiment of the case with a cutout showing internal details.

FIGS. 8a and 8b are behind views showing additional embodiments of the case.

FIGS. 9a, 9b and 9c are top and bottom views of additional embodiments of the case and 9d is a side view of an additional embodiment of the case.

FIG. 10a is a frontal view of an additional embodiment of the case with a cutout showing additional details and FIG. 10b is a side view of an additional embodiment of the case with a cutout showing additional details.

FIGS. 11a and 11b are behind views showing additional embodiments of the case.

FIGS. 12a and 12b are behind views showing additional embodiments of the case with an accessory.

FIGS. 13a and 13b are frontal views of embodiments of the case in different configurations.

FIGS. 14a and 14b are frontal views of embodiments of the case in different configurations.

FIGS. 15a and 15b are frontal views of embodiments of the case in different configurations.

FIGS. 16a and 16b are frontal views of embodiments of the case in different configurations.

FIG. 17 is a frontal view of an embodiment of the case with a cutout demonstrating internal features and a systemic outline of connection.

FIGS. 18a, 18b, 18c and 18d are frontal views of embodiments of the case with a cutout demonstrating internal features and a systemic outline of connections.

FIG. 19 is a systemic outline of an embodiment of the Present Invention and connections.

FIG. 20 is a systemic outline of an embodiment of the case with connections, internal processing and arrays.

FIGS. 21a, 21b, 21c and 21d are systemic outlines of an embodiment of the case and the interactions with hardware and software.

FIGS. 22a, 22b and 22c are systemic outlines of an embodiment of the case and the interactions with hardware and software.

### DETAILED DESCRIPTION AND EMBODIMENTS

Disclosed are methods, apparatus, and systems that may provide encasement of a device such as a mobile device to protect or isolate the device from outside forces, elements or substances that may damage, disable, scratch, break or harm the device. In addition to the protection, the present invention may add or supplement the features or characteristics within the phone, such as additional batteries, digital memory storage and any and all features which are embodied below.

Although the present embodiments have been described with reference to specific example embodiments, it will be evident that various modifications and changes may be made to these embodiments without departing from the broader spirit and scope of the various embodiments. Particularly, the present invention is not limited to the features exactly as mentioned, but the features as mentioned provide as an example to how the present invention may example and serve as an auxiliary or peripheral device with additional or supplemental features as well as adding protection and isolation. It should be understood by one of ordinary skill in the art that the terms describing processes, products, element, or methods are industry terms and may refer to similar alternatives. In addition, the components shown in the figures, their connections, couples, and relationships, and their functions, are meant to be exemplary only, and are not meant to limit the embodiments described herein.

Example embodiments are illustrated by way of example and are not limited to the figures of the accompanying drawings, in which, like references indicate similar elements.

In one or more embodiments, the present invention relates to a case.

In one or more embodiments, the present invention relates to a case for a device.

In or more embodiments, the present invention relates to a case for an electronic device.

In one or more embodiments, the present invention relates to a case for mobile devices.

In one or more embodiments, the present invention relates to a case for a device where the case may be made of one material.

In one or more embodiments, the present invention relates to a case for a device where the case may be made with one or more materials.

In one or more embodiments, the present invention relates to a case for a device where the case may be made of a synthetic material.

In one or more embodiments, the present invention relates to a case for a device where the case may be made of a natural material.

In one or more embodiments, the present invention relates to a case for a device where the case may be made of an alloy.

In one or more embodiments, the present invention relates to a case for a device where the case may be made of composite materials

In one or more embodiments, the present invention relates to a case for a device where the case may be made of a composite of materials

In one or more embodiments, the present invention relates to a case for a device wherein the case may be made of many materials wherein each material provides a specific characteristic, for example one area which contacts the hand of the user may be made of a rubber material to improve grip, while in another area the material used may be aluminum to provide strength and durability.

In one or more embodiments, the present invention relates to a case for a device wherein the case may be made of a softer material than the encased device to reduce scratches on the encased device.

In one or more embodiments, the present invention relates to a case for a device where the case may be made of a softer material on the inside of the case to reduce scratches on the encased device, but the outside of the case is made of a harder material to provide protection.

In one or more embodiments, the present invention relates to a case for a device where the case may be made of a softer material than the encased device to reduce scratches on the encased device, the middle layer of the case is of a harder or stronger material to provide protection, and the outside of the case is made of a soft material to increase grip in the user's hand

In one or more embodiments, the present invention relates to a case for a device wherein the case may be made of any plurality of materials in any formation.

In one or more embodiments, the present invention relates to a case for a device where the case may be made of any plurality of materials in any formation and of which the plurality of materials may be connected through any means, such as being formed together, fashioned together through any process such as two areas of different material may be fastened together either using a physical bond, such as a locking connection, through the use of an adhesive such as an epoxy other methods such as chemical bonds, welds or solder.

In another embodiment, which may be in addition to the above or below embodiments, the present invention relates to a case that may protect against outside elements.

In another embodiment, which may be in addition to the above or below embodiments, the present invention relates to a case that may protect against outside elements such as water, dust, liquids, particles or substances.

In another embodiment, which may be in addition to the above or below embodiments, the present invention relates to a case that may protect against outside elements that may be detrimental to the function, damage, ruin or otherwise make the encased device unusable either permanently or temporarily.

In another embodiment, which may be in addition to the above or below embodiments, the present invention relates to a case that may seal the encased device against all foreign substances and materials.

In another embodiment, which may be in addition to the above or below embodiments, the present invention relates to a case that may protect against outside forces.

In another embodiment, which may be in addition to the above or below embodiments, the present invention relates to a case that may protect against forces such as shock, impact, or other forces.

In another embodiment, which may be in addition to the above or below embodiments, the present invention relates to a case that may protect against forces which may be imparted from dropping or otherwise handling the device properly or improperly.

In another embodiment, which may be in addition to the above or below embodiments, the present invention relates to a case that may protect against the damage of the device from a force of any form or source, from any angle or disposition, and of any magnitude, amount, duration, frequency, impedance, or other characteristic.

In another embodiment, which may be in addition to the above or below embodiments, the present invention relates to a case that may protect against outside forces and be specifically designed for a certain protection, such as a screen shattering from a force which may have been imposed by the user dropping the device, or may provide certain protection such as within development, research or common knowledge, a certain device in which the case may be designed for, has a design flaw, of which the case then is designed specifically to strengthen, for instance within the iPhone 6, the structure having a design flaw of being easily bendable, and as such the case may be designed to strengthen the torsional rigidity of the structure or provide some other form of structure or feature.

In another embodiment, which may be in addition to the above or below embodiments, the present invention relates to a case that adds to the usability of the encased device such as increasing ergonomics, hand ability, grip, or any physical characteristic or user interface characteristic.

In another embodiment, which may be in addition to the above or below embodiments, the present invention relates to a case that adds to the usability of the encased device such as having connectors to provide further characteristics of the device such a connector to allow the use of external devices such as selfie sticks or other auxiliary devices.

In another embodiment, which may be in addition to the above or below embodiments, the present invention relates to a case that may add to the usability of the encased device such as providing the proper view ports to view displays or indicators on the device, proper membranes, cavities or access ports for speakers, microphones, sensors such as temperature sensors, light sensors or any other sensors and any other ports, membranes or openings to provide connections or any other use deemed by the design of device and one skilled in the art would foresee.

In another embodiment, which may be in addition to the above or below embodiments, the present invention relates to a case that may encase a device of any make, model, operating system, manufacturing date, version or size.

In another embodiment, which may be in addition to the above or below embodiments, the present invention relates to a case that may encase a mobile device of any make, model, operating system, manufacturing date, version or size.

In another embodiment, which may be in addition to the above or below embodiments, the present invention relates to a case that may encase a device of any make, model, operating system, manufacturing date, version or size such as an Apple iPhone running iOS or a Samsung Galaxy product running Android OS or tablets such as an Apple iPad running iOS or a Samsung Galaxy Product running Android OS.

In another embodiment, which may be in addition to the above or below embodiments, the present invention relates to a case that may be of any size not only to facilitate conforming to the encased device, but also to provide for further structure for its own features, such as being thicker to provide for more impact protection or thinner, which while providing less protection, provides a more manageable and ergonomical structure.

In another embodiment, which may be in addition to the above or below embodiments, the present invention relates to a case that may be of any size not only to facilitate conforming to the encased device, but also to provide different designs both for style and also for function such as an extrusion to protect buttons on the case or a cavity to allow for lenses or other structures to function within, on or as part of the case.

In another embodiment, which may be in addition to the above or below embodiments, the present invention relates to a case that may be of any size to not only facilitate confirming the encased device, but also to facilitate the cases structures such as batteries processors, memory stores, etc.

In another embodiment, which may be in addition to the above or below embodiments, the present invention relates to a case which may provide additional features.

In another embodiment, which may be in addition to the above or below embodiments, the present invention relates to a case which may provide additional features to the encased device.

In another embodiment, which may be in addition to the above or below embodiments, the present invention relates to a case which may provide enhancing features.

In another embodiment, which may be in addition to the above or below embodiments, the present invention relates to a case which may provide enhancing features to the encased device.

In another embodiment, which may be in addition to the above or below embodiments, the present invention relates to a case which may provide supplemental features.

In another embodiment, which may be in addition to the above or below embodiments, the present invention relates to a case which may provide supplemental features to the encased device.

In any embodiment any feature within the case that is redundant with the features or devices within the encased device, may be for the purpose of updating the encased device's feature or may provide a batter service, longevity, accuracy or other characteristic.

In another embodiment, which may be in addition to the above or below embodiments, the present invention relates to a case which may provide additional features in addition to traditional protection as found in device cases.

In another embodiment, which may be in addition to the above or below embodiments, the present invention relates to a case that may provide intelligent features to the encased device.

In another embodiment, which may be in addition to the above or below embodiments, the present invention relates to a case that may provide additional features to the encased device such as additional power storage capacity.

In another embodiment, which may be in addition to the above or below embodiments, the present invention relates to a case that may provide additional features to the encased device such as additional power storage capacity using batteries within the case.

In another embodiment, which may be in addition to the above or below embodiments, the present invention relates to a case that may provide additional features to the encased device such as additional enclosed, permanent or semi-permanent, power storage devices of which may be lithium, alkaline, carbon-zinc, NiMH, NiCd or any type of power storage, such as fuel cells, kinetic energy storage or production and any energy storage not mentioned or invented yet.

In another embodiment, which may be in addition to the above or below embodiments, the present invention relates to a case that may provide additional features to the encased device such as additional unenclosed, permanent or semi-permanent, power storage devices of which may be lithium, alkaline, carbon-zinc, NiMH, NiCad or any type of power storage, such as additional types of energy storage not mentioned or invented yet, fuel cells, kinetic energy storage or production, etc.

In another embodiment, which may be in addition to the above or below embodiments, the present invention relates to a case that may provide additional features to the encased device such as additional power storage wherein the case may accept removable or reusable batteries or storage devices which may rechargeable, one-time use, reusable or removable and of which may be a propriety type or design such as proprietary or custom sized battery devices and cells, proprietary or custom sized fuel cells, or other power storage devices, or of common use such as AA, AAA or any sized carbon-zinc batteries as commonly found in households.

In another embodiment, which may be in addition to the above or below embodiments, the present invention relates to a case that may provide additional features to the encased device such as additional power storage modules which are removable.

In another embodiment, which may be in addition to the above or below embodiments, the present invention relates to a case that may provide additional features to the encased device such as additional power storage modules which are non-removable.

In another embodiment, which may be in addition to the above or below embodiments, the present invention relates to a case that may provide additional features to the encased device such as additional power storage of which may be any size or capacity such as 2000 mah or 6000 mah. The power storage may be capable of a capacity one skilled in the art would find to be complimentary to the device and need of the user and may be optimized based on power needs and size, cell count, etc.

In another embodiment, which may be in addition to the above or below embodiments, the present invention relates to a case that may provide additional features to the encased device such as power storage which supplements the system power of the device constantly, supplements the system power of the devices passively, charges the device's battery while the device is on, charges the device's battery while the device is on, charges the device's battery while in or not in use or of any combination of the aforementioned features.

In another embodiment, which may be in addition to the above or below embodiments, the present invention relates to a case that may provide additional features to the encased device such as power storage which replaces the power storage within the device, such as the case power source being able to power the device as well as charge the device power storage, when the device power storage in missing, defective, broken or discharged completely discharged partially, or not discharged. This may provide the ability to keep the device's power storage at optimal level, while still continually using the device, by the device using the case's power source and maintaining the device's power storage at the preferred level.

In another embodiment, which may be in addition to the above or below embodiments, the present invention relates to a case that may provide additional features to the encased device such as additional ports.

In another embodiment, which may be in addition to the above or below embodiments, the present invention relates to a case that may provide additional features to the encased device such as additional ports such as communication ports with inboard, outboard or simultaneous communication either between the peripheral device and the case, peripheral device and the encased device, or separately or simultaneously.

In another embodiment, which may be in addition to the above or below embodiments, the present invention relates to a case that may provide additional features to the encased device such as additional ports such as power ports, communication ports or other multi-purpose ports that may provide power to the case including charging, may pass through power to the device encased, may power both the case and the device simultaneously or separately, may charge the case and the device simultaneously or separately, may charge the case and the device simultaneously or separately, may charge and power the case and the device simultaneously or separately, may provide power to the internal case battery or system battery to a device connected, such as a peripheral device such as a USB stick, camera etc.

In another embodiment, which may be in addition to the above or below embodiments, the present invention relates to a case that may provide additional features to the encased device such as additional ports such as power ports, communication ports or other multi-purpose ports that may provide communication abilities including communication with a peripheral device, such as a memory USB stick, camera, keyboard etc. to both the case system as well as the device system simultaneously or separately.

In another embodiment, which may be in addition to the above or below embodiments, the present invention relates to a case that may provide additional features to the encased device such as additional ports such as USB, USB 2.0, USB 3.0, USB-C, micro-USB, mini-USB, Apple 30pin connector, Apple Lightening connecter, Ethernet, e-SATA, HDMI or any other standardized or propriety ports.

In another embodiment, which may be in addition to the above or below embodiments, the present invention relates to a case that may provide additional features to the encased device such as additional ports such as power ports, communication ports or other multi-purpose ports that may be of any variety or input, such as a port that accepts the “A” designated side of a USB plug or another port that accepts the “B” side of a USB plug.

In another embodiment, which may be in addition to the above or below embodiments, the present invention relates to a case that may provide additional features to the encased device such as additional ports such as power ports, communication ports or other multi-purpose ports that may provide for direct or indirect connections to peripheral devices such as an audio port for powering and sending audio to be played through a peripheral device such as a speaker.

In another embodiment, which may be in addition to the above or below embodiments, the present invention relates to a case that may provide additional features to the encased device such as wireless abilities, such as the present invention including wireless cards, systems, chips, antennas and associated hardware to connect to external, additional internal, connect, separated, remote, or any other device.

In another embodiment, which may be in addition to the above or below embodiments, the present invention relates to a case that may provide additional features to the encased device such as wireless abilities that may include Bluetooth, Wi-Fi, FM, AM, NFC, RFID, IR or other wireless communication standards or methods.

In another embodiment, which may be in addition to the above or below embodiments, the present invention relates to a case that may provide additional features to the encased device such as wireless abilities which may include wireless charging through any method such as inductive charging.

In another embodiment, which may be in addition to the above or below embodiments, the present invention relates to a case that may provide additional features to the encased device such as communication abilities between the case and the encased device.

In another embodiment, which may be in addition to the above or below embodiments, the present invention relates to a case that may provide additional features to the encased device such as communication abilities between the case and the encased device which are of any wireless type.

In another embodiment, which may be in addition to the above or below embodiments, the present invention relates to a case that may provide additional features to the encased device such as communication abilities between the case and the encased device which are of any wireless type and of which may provide data in either direction, information in either direction, and may include pass through data, such as the case connecting to a keyboard and passing the information through to the device or vice versa.

In another embodiment, which may be in addition to the above or below embodiments, the present invention relates to a case that may provide additional features to the encased device such as communication abilities between the case and the encased device which are of any wired type.

In another embodiment, which may be in addition to the above or below embodiments, the present invention relates to a case that may provide additional features to the encased device such as communication abilities between the case and the encased device which are of any wired type such as the case pre-formed or forming to the encased device's shape and providing connector at the appropriate ports between the device and case to provide for communication

In another embodiment, which may be in addition to the above or below embodiments, the present invention relates to a case that may provide additional features to the encased device such as communication abilities between the case and the encased device which are of any wired type and of which may provide data in either direction, information in either direction, and may include pass through abilities, such as the case connecting to a keyboard, and passing the information through to the device or vice versa such as a connection that connects the encased device to the case, and the case then connects to an external HDMI connector and cord which transfers video from the device, to the case, and to an external screen, or vice versa, where video is transferred from a player, such as a Blu-ray Player via HDMI to the case, and then through a connector to the encased device.

In another embodiment, which may be in addition to the above or below embodiments, the present invention relates to a case that may provide additional features to the encased device such as communication abilities between the case and the encased device which are of any wireless type and of which may provide data in either direction, information in either direction, and may include pass through data, such as the case connecting to a keyboard wirelessly, and passing the information through to the device or vice versa.

In another embodiment, which may be in addition to the above or below embodiments, the present invention relates to a case that may provide additional features to the encased device such as the case may incorporate within, in or on its structure a processing device

In another embodiment, which may be in addition to the above or below embodiments, the present invention relates to a case that may provide additional features to the encased device such as the case may incorporate within, in or on its structure, a processing device or devices that may include a processing unit, memory storage such as flash storage, additional Ram, graphics processors, audio processors, logic processors, additional CPU or CPU cores for augmented or additional processing, removable memory, expansion buses, etc.

In another embodiment, which may be in addition to the above or below embodiments, the present invention relates to a case that may provide additional features to the encased device such as the case may incorporate within, in or on its structure, a processing device or devices, including the aforementioned components, that may augment the encased devices processes, memory, sensors, or other facilities.

In another embodiment, which may be in addition to the above or below embodiments, the present invention relates to a case that may provide additional features to the encased device such as the case may incorporate within, in or on its structure, a processing device or devices, including the aforementioned components, that may serve to facilitate processes or other aspects the case performs itself.

In another embodiment, which may be in addition to the above or below embodiments, the present invention relates to a case that may provide additional features to the encased device such as the case may incorporate within, in or on its structure, a processing device or devices, including the aforementioned components, that may serve to facilitate processes or other aspects of both the encased device and the case simultaneously.

In another embodiment, which may be in addition to the above or below embodiments, the present invention relates to a case that may provide additional features to the encased device such as the processing unit in the case may provide any function including data filtering, data manipulation, encryption, decryption, media streaming, power managing or any other aspect one skilled in the art would find to be necessary.

Within certain mobile device operating systems, such as within Apple iOS, the OS system level does not provide hooks or allow to divert data destined to a set location by to OS to another location during capture. These OS's may provide functionality though app extensions that allow manipulation or to change the data after capture, and as such, there is a need to have a software within the device.

As such, in some embodiments, in addition to the above and below embodiments, an application running on the encased device or case, of which may be propriety, another third party app, or an app or service from the encased device manufacture to, after the capture of the data, such as from a camera, relay, edit or manipulate the data to a proprietary app, which then may be able to write to the storage device in the encased device, or preferably in the case. A method may be to save an image or video directly to the peripheral storage which would require in-app camera functionality and as such may create a library with API hooks to share with a third party app to write directly to the peripheral storage such as in the case. This may be beneficial to third party application developers, thereby creating added value for them (increased incentive for users to purchase their app or to purchase our device).

In another embodiment, which may be in addition to the above or below embodiments, the present invention relates to a case that may provide additional features to the encased device such as the processing unit in the case may enlist the use of any operating system necessitated by the function of the device.

In another embodiment, which may be in addition to the above or below embodiments, the present invention relates to a case that may provide additional features to the encased device such as the case, using embedded or internal processors or other logic enabled devices,being able to run software or other machine-readable data or machine-logic to perform a function.

In another embodiment, which may be in addition to the above or below embodiments, the present invention relates to a case that may provide additional features to the encased device such as the case, using embedded or internal processors or other logic enabled devices, to be able to run software or other machine-logic functions to perform a function or specific purpose.

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose of which may be parallel to, auxiliary to, supplemental, or in place of functions performed by the encased device.

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose such as to incorporate an operating system or other form of logic processes to aide in the use of the encased device or the case.

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose of which may be parallel to, auxiliary to, supplemental to, or in place of functions performed by the encased device.

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose of which may be to facilitate the use of the additional features, such as sensors and emitters within the case.

In another embodiment, which may be in addition to the above or below embodiments, the present invention relates to a case that may provide additional features to the encased device such as the case, using embedded or internal processors or other logic enabled devices to be able to run or process software or other machine-logic functions to perform a function or specific purpose of which may be to facilitate the use of the additional features, such as sensors and emitters within the case such as to process the inputs from the features, such as a signal from a sensor, into a machine readable format, and either display or otherwise use the information within the case, such as using the processors and other software to perform an action or relay the information from the sensor to the encased device.

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose such as to provide a basis for the encased device to communicate or enlist the additional features and devices within the case, such as additional memory storage,

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose such as to aide in the integration or provide a basis for integration of the case and the features of the case as an extension of the encased device and of the device intelligences The additional intelligence and capabilities would require additional memory for data storage and processing of which can be supplemented by the device and device intelligence and logic processes mentioned.

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose of which may be a custom or proprietary design or off the shelf design such as Google Android OS, Apple iOS, Apple OS, Microsoft Window, Linux, Blackberry OS, or any manufacture.

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose of which may be multiple software running simultaneously on different processors, the same processor, in conjunction with the encased device or in any combination to aide in communication, efficiency and increased compatibility.

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose of which may enlist the logic processes of the software to be performed in the encased device but the output, whether it is video or other information be displayed or used within the encased device or vice versa where the processes may be performed on the device, and the information or other features be displayed or otherwise used on or in the case.

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose of which may be upgradable or replaceable either by the user, manufacturer, issuer such as a cellphone company, or other entity such as an employer, and can be performed over the internet such as over the wireless cellular data connection of the device, in person such as in a store, or in any method.

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose such as the software in the case and the device synching or collaborating for a purpose.

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose such as the software in the case and the device synching or collaborating for a purpose such as to provide a seamless communication connection for all features between the encased device and case.

In another embodiment, which may be in addition to the above or below embodiments, the present invention relates to a case that may provide additional features to the encased device such providing a proprietary software which may be run on the encased device.

In another embodiment, which may be in addition to the above or below embodiments, the present invention relates to a case that may provide additional features to the encased device such providing a proprietary software which may be run on the encased device in collaboration or simultaneously as software running on the case.

In another embodiment, which may be in addition to the above or below embodiments, the present invention relates to a case that may provide additional features to the encased device wherein the software run on the encased device is not proprietary, but provided by a third party or generic.

In another embodiment, which may be in addition to the above or below embodiments, the present invention relates to a case that may provide additional features to the encased device wherein the software run on the encased device is automatically installed on the device upon the encased device encasement.

In another embodiment, which may be in addition to the above or below embodiments, the present invention relates to a case that may provide additional features to the encased device wherein the software run on the encased device is automatically installed on the device upon the encased device encasement from a memory storage on the case

In another embodiment, which may be in addition to the above or below embodiments, the present invention relates to a case that may provide additional features to the encased device wherein the software run on the encased device is automatically downloaded from a network or the internet and then installed on the device upon the encased device encasement.

In another embodiment, which may be in addition to the above or below embodiments, the present invention relates to a case that may provide additional features to the encased device wherein the software run on the encased device is automatically downloaded or installed on the device upon the encased device encasement with no user input.

In another embodiment, which may be in addition to the above or below embodiments, the present invention relates to a case that may provide additional features to the encased device wherein the software run on the encased device is automatically downloaded or installed on the device upon the encased device encasement and automatically opens, performs a function, or performs multiple function with user input, little user input or no user input.

In another embodiment, which may be in addition to the above or below embodiments, the present invention relates to a case that may provide additional features to the encased device such providing a proprietary software which may be run on the encased device which provides a communication ability for data to be sent or otherwise manipulated or captured from the encased device to the case.

In another embodiment, which may be in addition to the above or below embodiments, the present invention relates to a case that may provide additional features to the encased device such as providing a proprietary software to be run on the encased device which may provide a communication ability for data to be sent or otherwise manipulated or captured from the encased device to the case such as a proprietary software running on the device, which captures data from the encased device camera, edits or manipulates the data and then sends the data to the device.

In another embodiment, which may be in addition to the above or below embodiments, the present invention relates to a case that may provide additional features to the encased device such providing a proprietary software to be run on the encased device which provides a communication ability for data to be sent or otherwise manipulated or captured from the encased device to the case such as a proprietary software running on the device, which captures data from the encased device camera, edits or manipulates the data and then sends the data to the device, specifically to the peripheral memory storage in the case.

In another embodiment, which may be in addition to the above or below embodiments, the present invention propriety software may also be within the OS itself such as a file manager, or software provided by the OS, such as a stock camera app or memory manager service, or also may be a third party application such as a third party camera app or memory manger application of which may be able to write directly to the present invention case memory or other aspect.

In another embodiment, which may be in addition to the above or below embodiments, the present invention relates to a case that may provide additional features to the encased device such providing a proprietary software to be run on the encased device of which may be able to allow the encased device to communicate, send data, manipulate data or otherwise change or edit data either on the encased device, on the case, connected in any manner to the encased device, connected in any manner to the case, or provide a machine function that allows the software to do so on the case either directly or through a communication ability.

In another embodiment, which may be in addition to the above or below embodiments, the present invention relates to a case that may provide additional features to the encased device such providing a proprietary software to be run on the encased device that supersedes or overcomes the ability of the OS on the device to allow the case to access or the encased device to access, or vice versa to send, edit, capture or manipulate data from the encased device to the case either directly or through the proprietary application, third party application or by any method direct or indirect.

In another embodiment, which may be in addition to the above or below embodiments, the present invention relates to a case that may provide additional features to the encased device such providing a software that may be of an open source platform.

In another embodiment, which may be in addition to the above or below embodiments, the present invention relates to a case that may provide additional features to the encased device such providing a software that may be of an open source platform.

In another embodiment, which may be in addition to the above or below embodiments, the present invention relates to a case that may provide additional features to the encased device such providing an architecture for user programmed or written software at any architecture level.

In another embodiment, which may be in addition to the above or below embodiments, the present invention relates to a case that may provide additional features to the encased device such providing a software that is open source and user programmable.

In another embodiment, which may be in addition to the above or below embodiments, the present invention relates to a case that may provide additional features to the encased device such providing a software that is open source and user programmable and of which may be shared among users across any platform, such as a proprietary networked or online sharing software or service, the Apple Store, Google Play Store, or any other third party, generic or other software such as torrent services etc.

In another embodiment, which may be in addition to the above or below embodiments, the present invention relates to a case that may provide additional features to the encased device such providing a software that is open source and user programmable and of which may be shared among users across any platform for free or for a price.

In another embodiment, which may be in addition to the above or below embodiments, the present invention relates to a case that may provide additional features to the encased device such providing a software that is open source and user programmable and of which may be shared among users across any platform for free or for a price wherein the user may receive all the benefits, a portion of the benefits, or no benefits, and wherein the case company, the host of the platform may receive all the benefits, a portion of the benefits or no benefits.

In another embodiment, which may be in addition to the above or below embodiments, the present invention relates to a case that may provide additional features to the encased device such providing a proprietary software to allow the encased device to write or read directly to the case, such as the proprietary memory storage in the case.

In another embodiment, which may be in addition to the above or below embodiments, the present invention relates to a case that may provide additional features to the encased device such allowing the encased device to write or read directly to the case, such as the proprietary memory storage in the case.

In another embodiment, which may be in addition to the above or below embodiments, the present invention relates to a case that may provide additional features to the encased device such providing a proprietary software to allow the encased device to write or read directly to the memory storage on the case and as such so that the data stays with the user and not on a cloud or networked location, therefore accessible at any time without having to connect to the internet to access it as the case with online or cloud storage systems.

In another embodiment, which may be in addition to the above or below embodiments, the present invention relates to a case that may provide additional features to the encased device such the case able to write directly to the encased device such as a memory storage in the case, or provide data to the encased device to be used or manipulated by the encased device or software on the encased device either directly, using a proprietary software, third party software or the OS software.

In another embodiment, which may be in addition to the above or below embodiments, the present invention relates to a case that may provide additional features to the encased device such as the case, using embedded or internal processors or other logic enabled devices to be able to run software or other machine-logic functions to perform a function or specific purpose such as the software in the case and the device synching or collaborating for a purpose such as to provide a more secure device, such as the case providing further security features such as a fingerprint reader and the device software being locked with a high encryption or other method both on the case and the encased device so that the device or case cannot be used or accessed without proper authentication.

In another embodiment, which may be in addition to the above or below embodiments, the present invention relates to a case that may provide additional features such as further security measures such as a fingerprint reader or other biometric features.

In another embodiment, which may be in addition to the above or below embodiments, the present invention relates to a case that may provide additional features such as encryption technology, physical security or other deterrence whether hardware or software based, of which the case provides or supplements so the encased device and case are made more secure.

In another embodiment, which may be in addition to the above or below embodiments, the present invention relates to a case that may provide additional features to the encased device such as security measures of which the encased device or the case may not be able to be used or otherwise accessed, such as locking both with encryption, without the authentication of the user.

In another embodiment, which may be in addition to the above or below embodiments, the present invention relates to a case that may provide additional features to the encased device such as providing additional security measures of which may be active security measures.

In another embodiment, which may be in addition to the above or below embodiments, the present invention relates to a case that may provide additional features to the encased device such as providing additional security measures of which may be active security measures such as when the case senses movement, the case uses a connection to alert the user to a movement of the device, such as an email or alerting the user locally such as a sound being played through either the encased device speaker or a speaker within the case.

In another embodiment, which may be in addition to the above or below embodiments, the present invention relates to a case that may provide additional features to the encased device as an extension of the case.

In another embodiment, which may be in addition to the above or below embodiments, the present invention relates to a case that may provide additional features to the encased device as an extension of the case attached on any edge or in any method or disposition.

In another embodiment, which may be in addition to the above or below embodiments, the present invention relates to a case that may provide additional features to the encased device as an extension of the case attached on any edge or in any method or disposition such as one or more coupling hinge or hinges.

In another embodiment, which may be in addition to the above or below embodiments, the present invention relates to a case that may provide additional features to the encased device as an extension of the case attached on any edge or in any method or disposition such as one or more coupling hinge or hinges which are permanently connected

In another embodiment, which may be in addition to the above or below embodiments, the present invention relates to a case that may provide additional features to the encased device as an extension of the case attached on any edge or in any method or disposition such as one or more coupling hinge or hinges which are able to be disconnected.

In another embodiment, which may be in addition to the above or below embodiments, the present invention relates to a case that may provide additional features to the encased device that serve as additional human interface devices.

In another embodiment, which may be in addition to the above or below embodiments, the present invention relates to a case that may provide additional features to the encased device that serve as additional human interface devices as an extension of the case.

In another embodiment, which may be in addition to the above or below embodiments, the present invention relates to a case that may provide additional features to the encased device such as a foldable keyboard.

In another embodiment, which may be in addition to the above or below embodiments, the present invention relates to a case that may provide additional features to the encased device that serve as additional human interface devices as an extension of the case such as a foldable keyboard drawing pad or any other interface device.

In another embodiment, which may be in addition to the above or below embodiments, the present invention relates to a case that may provide additional features to the encased device such as providing connection to one or more peripheral devices.

In another embodiment, which may be in addition to the above or below embodiments, the present invention relates to a case that may provide additional features to the encased device such as providing connection to one or more peripheral devices external to the case.

In another embodiment, which may be in addition to the above or below embodiments, the present invention relates to a case that may provide additional features to the encased device such as providing connection to one or more peripheral devices internal to the case.

In another embodiment, which may be in addition to the above or below embodiments, the present invention relates to a case that may provide additional features to the encased device such as providing connection to peripheral devices through the use of any connection, of which may be wireless or wired.

In another embodiment, which may be in addition to the above or below embodiments, the present invention relates to a case that may provide additional features to the encased device such as providing connection to peripheral devices which may be of any type, such as external memory, speakers, random number generators, LEDs, LCDs, audio devices, chargers, other mobile devices, human interface devices such as mice, keyboards or joysticks, laptop computer, portable computer, desktop computers, medical peripheral devices such as heart monitor devices, blood sugar level devices, sleep monitoring devices, or any other medical related devices, networking devices such as routers modems, etc. and any other device one skilled in the art would intend.

In another embodiment, which may be in addition to the above or below embodiments, the present invention relates to a case that may provide additional features to the encased device such as providing additional sensors.

In another embodiment, which may be in addition to the above or below embodiments, the present invention relates to a case that may provide additional features to the encased device such as providing additional sensors internal to the case, connected, clamped or attached to the case or device or external to the device and case and of which may be powered by the device, powered by the case, or externally powered.

In another embodiment, which may be in addition to the above or below embodiments, the present invention relates to a case that may provide additional features to the encased device such as providing additional sensors connected via wireless methods, wired methods, or other methods.

In another embodiment, which may be in addition to the above or below embodiments, the present invention relates to a case that may provide additional features to the encased device such as providing additional sensors in any plurality, and of which may be enlisted one at a time, or many or all simultaneously.

In another embodiment, which may be in addition to the above or below embodiments, the present invention relates to a case that may provide additional features to the encased device such as providing additional sensors of which may be of any type.

In another embodiment, which may be in addition to the above or below embodiments, the present invention relates to a case that may provide additional features to the encased device such as providing additional sensors in the case, attached to the case, or external of which are redundant with sensors within the encased device.

In another embodiment, which may be in addition to the above or below embodiments, the present invention relates to a case that may provide additional features to the encased device such as providing additional sensors in the case, attached to the case, or external of which are redundant with sensors within the encased device and may be of higher accuracy or any measurement in relation to the sensor concurrently in the device.

In another embodiment, which may be in addition to the above or below embodiments, the present invention relates to a case that may provide additional features to the encased device such as providing additional sensors of which the sensors may be accelerometers, location based sensors such as GPS sensors, temperature sensors, sound or acoustical sensors such as microphones, ambient sensors such as temperature sensors, barometers, altimeters, humidity sensors, magnetic sensors such as used for a compass, RFID or NFC sensors, light sensing sensors such as ambient lighting sensors or photo detectors, photo and video sensors for recording photos or videos in any resolution, photographs or other recording mediums, vibrational sensors, movement sensors, such as those used to indicate when the device is picked up or dropped so the device can provide readiness for shock, such as for hard drive protection or camera lens protection, additional cellular, or other communication antennas, such as for Bluetooth which may augment the encased device's antennas, as well as any and all sensors the intended use of the device would dictate.

In another embodiment, which may be in addition to the above or below embodiments, the present invention relates to a case that may provide additional features to the encased device such as providing additional sensors of which may be able to actively sense the surroundings constantly.

In another embodiment, which may be in addition to the above or below embodiments, the present invention relates to a case that may provide additional features to the encased device such as providing additional sensors of which may be able to sense the surroundings only at scheduled times or in the response of user input.

In another embodiment, which may be in addition to the above or below embodiments, the present invention relates to a case that may provide additional features to the encased device such as providing additional sensors to aid in the device's use. An example may be a GPS sensor in the case providing GPS coordinates to an application or software running on the encased device or the case and aiding in determining the event of the user arriving at a predetermined geospatial location such as the user's home, and as such allowing the device or case to perform actions such as upon arriving at home sending a wireless signal over Wi-Fi, Cellular, IR or Bluetooth to a device in the home that may perform a function such as turning on the lights, opening the garage door, turning on the air conditioning, etc. An example can be that the encased device already has a GPS antenna, but the GPS antenna is not strong enough to receive signals indoors, and as such a more robust GPS antenna may exist in the case, as to provide a better signal indoors, and of which the case or encased device may use to track the user, and automatically perform actions such as turning on or off lights or appliances as the user changes locations.

In another embodiment, which may be in addition to the above or below embodiments, the present invention relates to a case that may provide additional features to the encased device such as providing additional sensors or methods to alert the user if the user moves away or changes from a certain criteria such as if the device or encased device or user moves too far away from a certain geospatial location or moves away from a certain object, such as a wallet, or if the user exceeds a certain speed, such as a speed warning for driving or biking.

In another embodiment, which may be in addition to the above or below embodiments, the present invention relates to a case that may provide additional features to the encased device such as providing additional emitters.

In another embodiment, which may be in addition to the above or below embodiments, the present invention relates to a case that may provide additional features to the encased device such as providing additional emitters internal to the case, connected, clamped or attached to the case or device or external to the device and case.

In another embodiment, which may be in addition to the above or below embodiments, the present invention relates to a case that may provide additional features to the encased device such as providing additional emitters connected via wireless methods, wired methods, or other methods and of which may be powered by the device, powered by the case, or externally powered.

In another embodiment, which may be in addition to the above or below embodiments, the present invention relates to a case that may provide additional features to the encased device such as providing additional emitters in any plurality, and of which may be enlisted one at a time, more than one at a time or all simultaneously.

In another embodiment, which may be in addition to the above or below embodiments, the present invention relates to a case that may provide additional features to the encased device such as providing additional emitters of which may be of any type.

In another embodiment, which may be in addition to the above or below embodiments, the present invention relates to a case that may provide additional features to the encased device such as providing additional emitters in the case, attached to the case or external to the case of which are redundant with emitters within the encased device.

In another embodiment, which may be in addition to the above or below embodiments, the present invention relates to a case that may provide additional features to the encased device such as providing additional emitters in the case, attached to the case, or external to the case of which are redundant with emitters within the encased device and may be of higher strength, accuracy or any measurement in relation to the emitters concurrently in the device.

In another embodiment, which may be in addition to the above or below embodiments, the present invention relates to a case that may provide additional features to the encased device such as providing additional emitters of which the emitters may be light emitters such as LED's, OLED'S, halogen, or of any type, sound emitters, such as a speaker or any other sound emitters, heat emitters such as to keep the encased device from freezing in extreme temperatures, movement emitters, such as a vibration motor such as to notify the user such as if a location has been reached or an email has been received.

In another embodiment, which may be in addition to the above or below embodiments the sensors and emitters may form a radio, such as forming the aforementioned Wi-Fi card but also may be of any type of radio which receives and sends information over any medium.

In another embodiment, which may be in addition to the above or below embodiments, the present invention relates to a case that may provide additional features to the encased device such as providing additional emitters of which may be able to actively emit to the surroundings constantly.

In another embodiment, which may be in addition to the above or below embodiments, the present invention relates to a case that may provide additional features to the encased device such as providing additional emitters of which may be able to emit to the surroundings only at scheduled times or in the response of user input.

In another embodiment, which may be in addition to the above or below embodiments, the present invention relates to a case that may provide additional features to the encased device such as providing additional emitters to indicate to the user certain aspects, such a LED indicator with multiple LEDs of different colors, emitting green when the device or case is fully charged and red when depleted, or a single LED emitting a color such as blue when connected via Bluetooth etc. The emitters may be of any plurality, designation, design, orientation, color, etc. of which benefits the ability to inform the user or perform the necessitated action

In another embodiment, which may be in addition to the above or below embodiments, the present invention relates to a case that may provide additional features to the encased device such as providing additional emitters or methods to alert the user if the user moves away from the device or location or other device past a certain distance or other aspects.

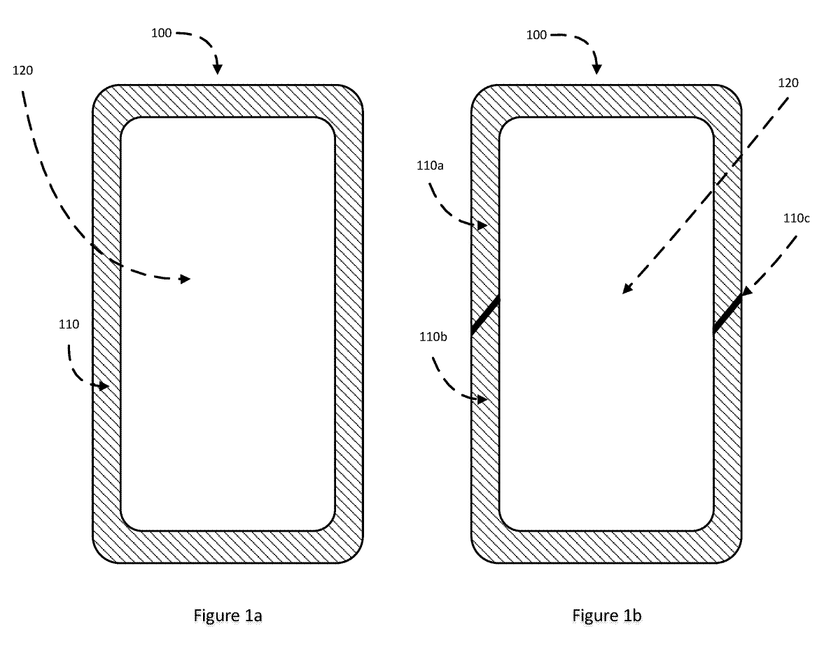

FIGS. 1a and 1b are frontal views showing embodiments of the case. FIG. 1a shows case 100 with a facade 110 and cavity 120. The case 100 may employ a grip or friction fit style case in which the device is inserted into the cavity 120, which may be sized slightly smaller than the device, but the material may give, stretch, morph or otherwise accommodate to allow the device to slip in, engage or otherwise be retained. Other methods can be ascertained in the retention of the device within the case that are implied from Prior Arts and one skilled in the art would intend. The facade 120 may overlap over the device, or not overlap over the device depending on the design in order to secure the device. FIG. 1b is an additional embodiment of the present invention similar to FIG. 1a, but teaches to a two piece design for the case 100, of which is made up of 110a and 100b. 100a first piece, may couple or otherwise connect with second piece 110b using any method such as interlocking structures, suction, tension, adhesion or otherwise such as in the example embodiment of a coupling area 110c.

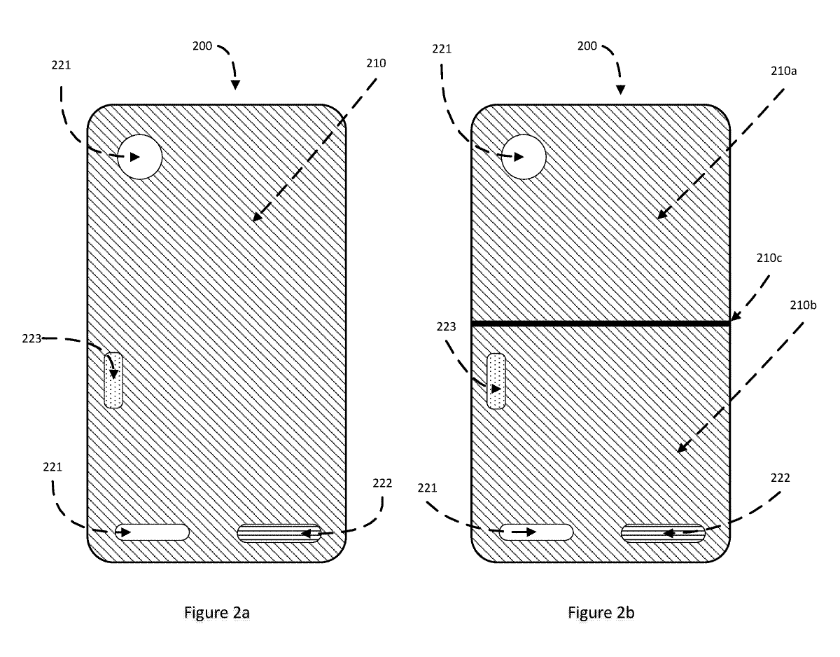

FIGS. 2a and 2b are behind views showing embodiments of the case. FIG. 2a shows the case 200 with case back 210. The case back 210 may include cavities 221 of which are in exampled positions but as aforementioned may be in any position or location to facilitate the design of the encased device such as providing a cavity to facilitate the use of a camera or sensor within the encased device. The cavities may also provide for a structure of a lens or other material to span the cavity, either extruding, intruding or flush with the case in order to facilitate the use of structures of the phone or of the case. Case back 210 may also include access ports 222 or membranes 223 in any location or disposition to facilitate the encased device or internal workings or structures in the case itself, such as speakers, plugs, ports, etc. FIG. 2b is similar in design to the embodiment as in FIG. 2a but portrays a two piece design of the case of which includes first piece 210a and second piece 210b. 210a first piece, may couple or otherwise connect with second piece 210b using any method such as interlocking structures, suction, tension, adhesion or otherwise such as in the example embodiment of a coupling area 210c.

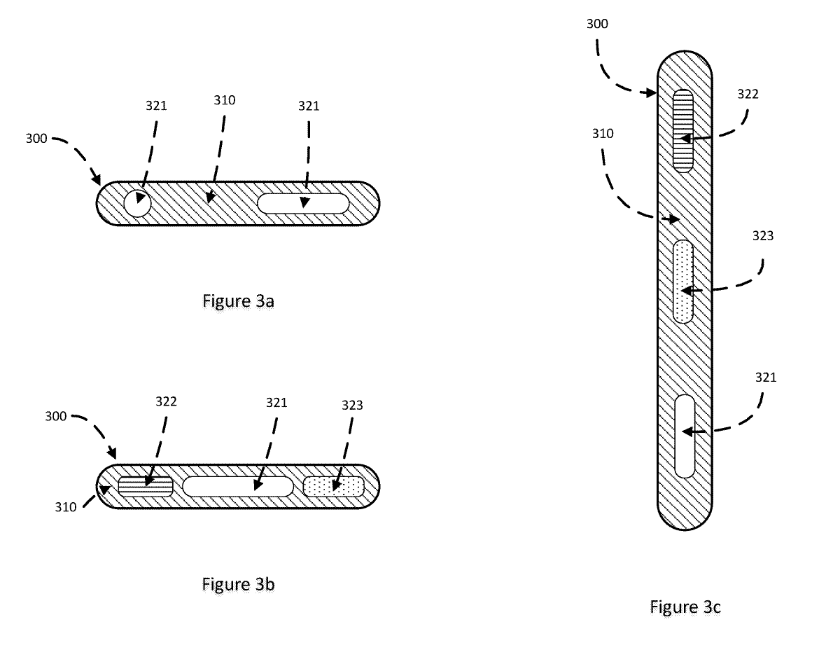

FIGS. 3a and 3b are top and bottom views of embodiments of the case and 3c is a side view of an embodiment of the case. FIG. 3a embodies a bottom or top view of the present invention and includes the body of the case 310, and cavities 321 of which aforementioned may have the capability of providing access to ports or otherwise facilitate the use of the encased devices. FIG. 3b embodies a bottom or top view of the present invention and includes the body of the case 310, cavities 321, membranes 322 or extrusions or indentations of which may facilitate the use of certain structures of the encased device or of the case which may be representative of buttons on the encased device or buttons which control functions of the case. FIG. 3c embodies a bottom or top view of the present invention and includes the body of the case 310, cavities 321, membranes 322 or extrusions or indentations of which may facilitate the use of certain structures of the encased device or of the case which may be representative of buttons on the encased device or buttons which control functions of the case.

It is noted that in any of the embodiments and figures that any structures, locations, sizes shapes, characteristics and dispositions are merely representative and may be changed either for use, type, function of the encased device or the present invention's need.

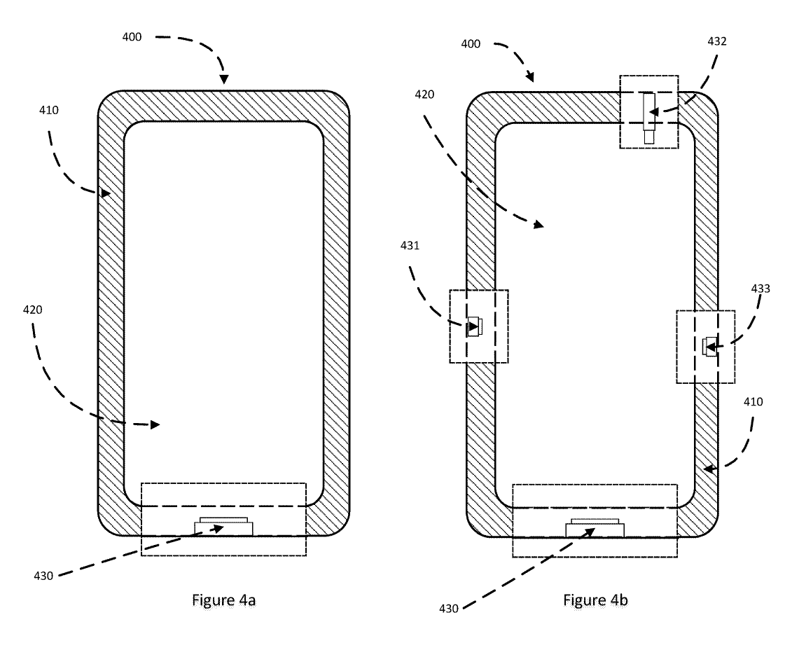

FIGS. 4a and 4b are frontal views of embodiments of the case with cutouts demonstrating internal details. FIG. 4a embodies a front view of the present invention 400 with cavity 420 which may be sized slightly smaller than the device, but the material may give, stretch, morph or otherwise accommodate to allow the device to slip in, engage or otherwise be retained. Other methods can be ascertained in the retention of the device within the case that are implied from Prior Arts and one skilled in the art would intend. The facade 410 may overlap over the device as well to facilitate in the retention of the encased device. Within the cutout an internal mechanism is shown that represents a plug 430 of which may provide a data or power connection from the case to the encased device. The plug 430 may be of any type or size in respect to the encased device and application. There may also be a multitude of plugs 430. The plug or plugs may provide data connection and power connection of which provides may feed through from the case or connects to structures in the case itself. FIG. 4b also embodies the front view of the present invention 400 with cavity 420 and facade 410 as well as cutouts exampling locations sizes and types of the plugs of which may be positions anywhere or of any type, but are exampled as Apple Lightning plug 432, aux plug 432, USB plug 433, and 30pin connection 430.

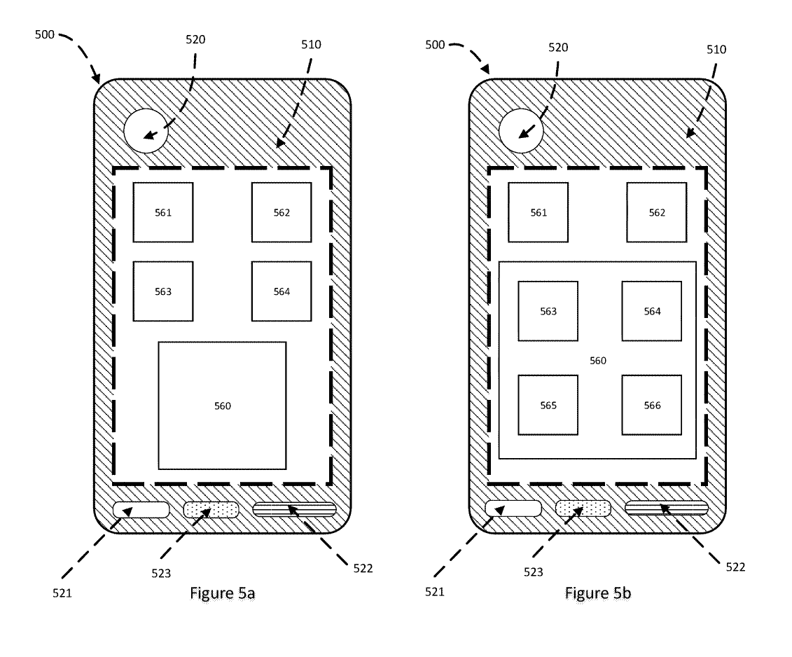

FIGS. 5a and 5b are behind views showing embodiments of the case with cutouts demonstrating internal details. FIG. 5a is a behind view exampling the facade 510 and cavities 521 as well as membranes 523 and extrusions or indentations 522 with a cutout showing internal details. The internal details embody an example of internal structures, of which through this example may be of any other type, size, location, plurality, disposition or other characteristic and of which may be designed to complement a need or structure of the encased device. Exampled are battery 560, processor 561, memory storage 562, communications or wireless hub 563, and bus 564. FIG. 5b shows an additional embodiment with the aforementioned internal structures organized in different locations, sizes and pluralities of which includes battery 560, of which may be stacked on either side of the other structures of which may be 561 processor, 562 memory storage ,563 communications or wireless hub or antenna, bus 564, sensors 565, or other structure 566. FIG. 5b is an embodiment which then represents the ability for any disposition of the internal structures to be facilitated.

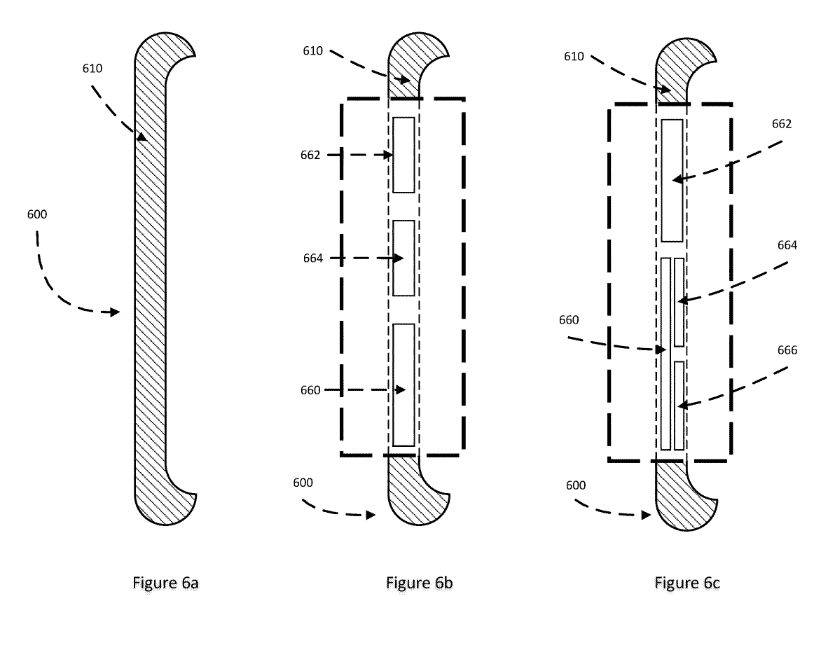

FIGS. 6a, 6b and 6c are side views showing embodiments of the case with cutouts demonstrating internal details, FIG. 6a is a side profile of the present invention 600 showing the facade 610. The angle at which provides the encompassing ends of the device may be of any angle or size, depending on the characteristics necessitated by the user or the encased device. FIG. 6b embodies a side profile of the present invention with a cutout showing the internal structures of the case. These can include, among the other aforementioned structures, a battery or storage device 660, memory storage 662 and bus 664. These devices may be of any size or disposition. FIG. 6c is also a side view of an embodiment of the inventions with a cutout showing internal structures of which may be the aforementioned battery 660, memory storage 662, bus 664 or other structure 666. Of note this embodiments represents the ability for the present invention to have structures that may be of overlapping dispositions to each other but is not limited to the locations as embodied but may be of any disposition.

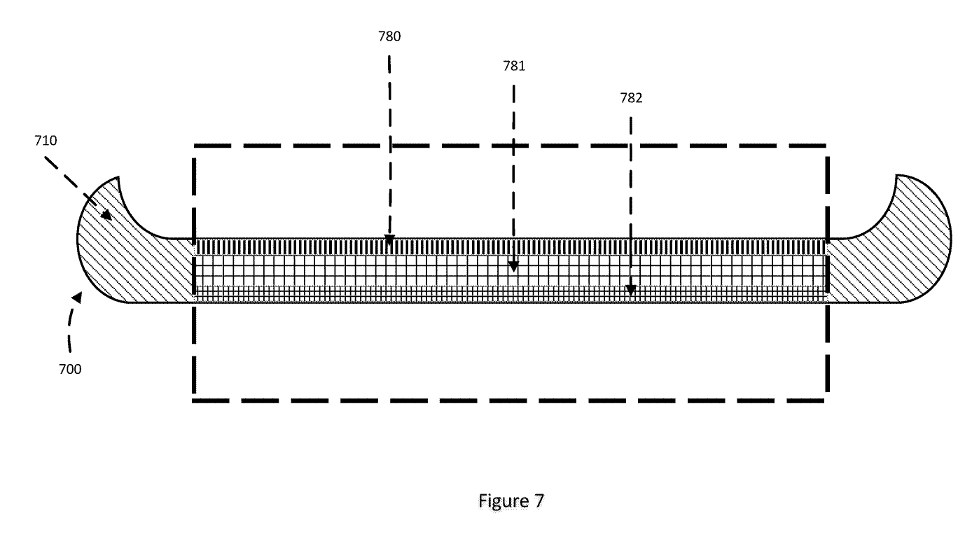

FIG. 7 is a side view showing an embodiment of the case with a cutout showing internal details. FIG. 7 is a side profile of the present invention case 700 with facade 710. The cutout area shows example layering of the material of the case structure of which may be any multitude of materials such as one material 880, second material 881 and third material 882. The device may also have four or more materials or less than four materials depending on the need of the user and device. In the embodiment within FIG. 7 the materials may be stacked or layered, but also may be impregnated or otherwise disposed in any method such as one material directly underneath the facade material, and another material making up the core, or any other design, material or structure one skilled in the art would reasonably intend.

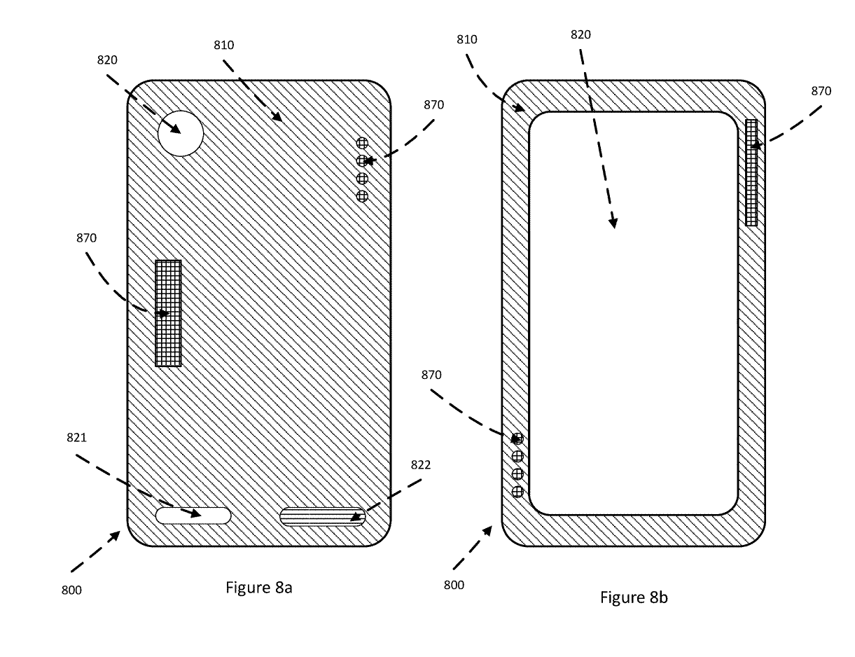

FIGS. 8a and 8b are behind views showing additional embodiments of the case. FIG. 8a shows a behind view of the present invention with the aforementioned features, and additional features of emitters or sensors 870. The emitters or sensors may be of any type as mentioned above such as LED emitters making a display or charge level, or also may be sensors such as temperature sensors. The sensors as featured in the embodiment of 8a are merely representational and may be of any location, size disposition or purpose to provide for any necessitated characteristic. FIG. 8b shows a front view of an embodiment of the present invention with example locations and dispositions of the sensors or emitters 870.

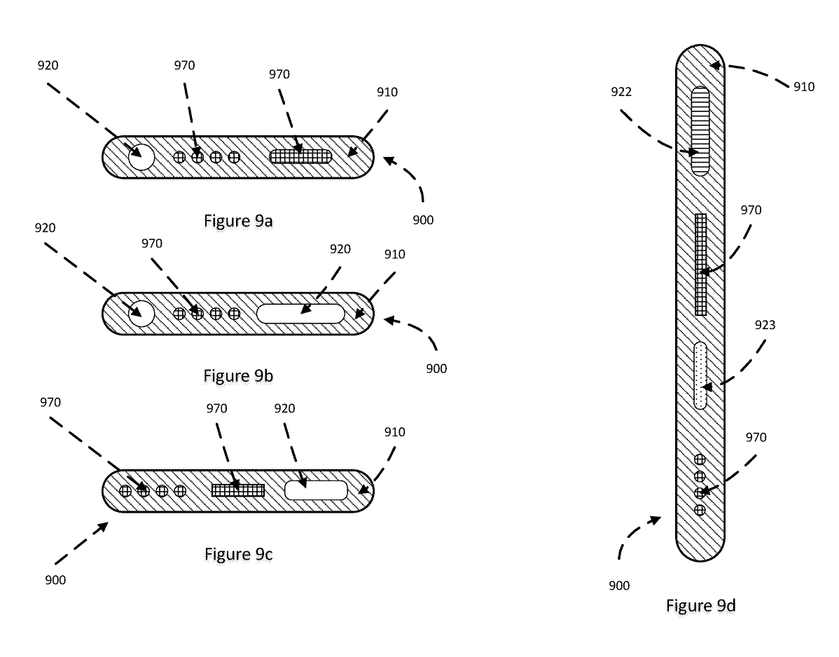

FIGS. 9a, 9b and 9c are top and bottom views of additional embodiments of the case and 9d is a side view of an additional embodiment of the case. FIG. 9a is a top or bottom view of the case with aforementioned features and additional sensors or emitters 970 of which may be of any location, disposition or plurality. FIGS. 9b and 9c are additional examples of embodiments with different positions of the aforementioned features and the sensors or emitters 970 of which may be of any size, location, disposition or plurality as demonstrated or one skilled in the art would intend. FIG. 9d is a side view of an embodiment of the case of which teaches to the aforementioned features in addition to the sensors or emitters 970 of which may be located and disposed at a location, disposition, size or plurality exampled or one skilled in the art would intend.

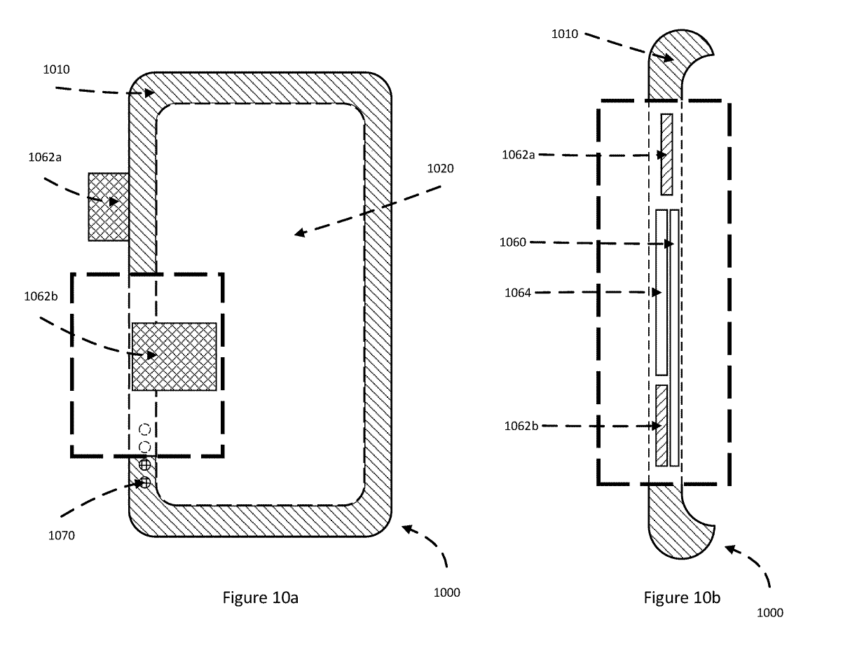

FIG. 10a is a frontal view of an additional embodiment of the case with a cutout showing additional details and FIG. 10b is a side view of an additional embodiment of the case with a cutout showing additional details. FIG. 10a is a front view of an embodiment of the present invention with the aforementioned features and also teaching to ports, dock or removable aspects of the case such as memory cards, expansions devices such as additional memory, processing or communication devices such as sim cards or wireless communication cards, such as a car providing a Wi-Fi antenna and associated circuitry. These expandable devices, exampled by 1062a and 1062b may be inserted into the device and are retained by the device in any method such as captive springs, friction or any other method. 1062a examples that the device may extrude form the case but also the inserted devices may be flush with the exterior of the case, or internal to the case as shown in the cutout area and 1062b external device. It is noted that device ports and corresponding devices may be of any type size, plurality or disposition such as two or more sim cards, or two or more memory cards. They may be able to extrude into any side of the case and may be connected to the case facilities or use the case as a pass-through for data or power to the encased device. FIG. 10b is a side view of an embodiments showing the aforementioned features and example placements of the external device 1062a and 1062b of which may be in any position, and as exampled in 1062b may be stake under or below other structures within the device.

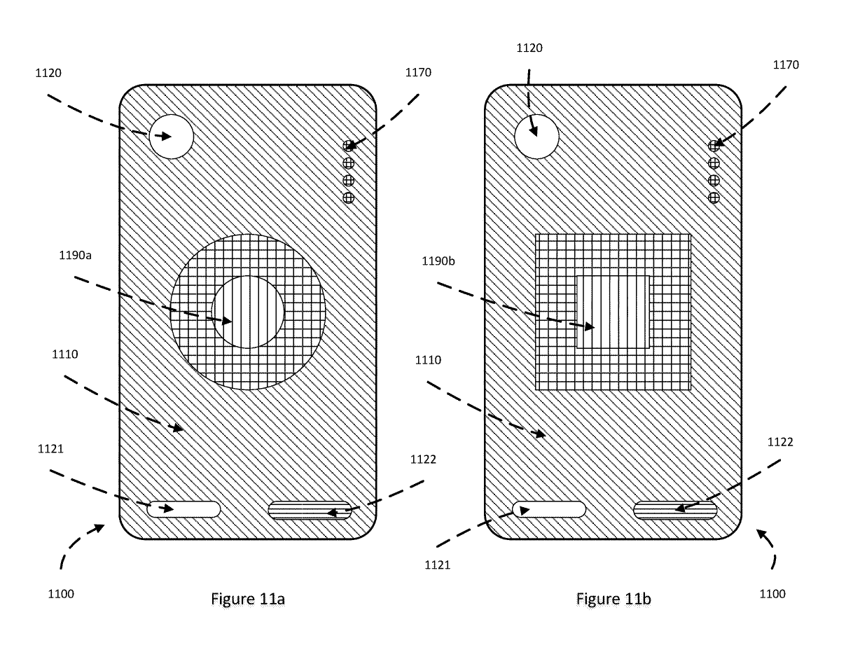

FIGS. 11a and 11b are behind views showing additional embodiments of the case. FIG. 11a is a behind view of the case with the aforementioned structures and features and also teaches to a coupling 1190a. FIG. 11b shows an additional example coupling style 1190b. This coupling may be of any method such as a captive nut or other receptive method such as ¼-20 UNC thread or ⅜-16 UNC threads, plus a removable ¼-20 UNC adapter. The coupling 1190a and 1190b as displayed in FIGS. 11a and 11b are representative and may be of any size, location, and disposition and also may have different pluralities. Additionally, more than one coupling may be present and used by one, or many devices. The couplings 1190a and 1190b may be made of the same material as the facade 1110 or of any other material, such as aluminum to add strength and reduce wear, but still be lightweight and compact.

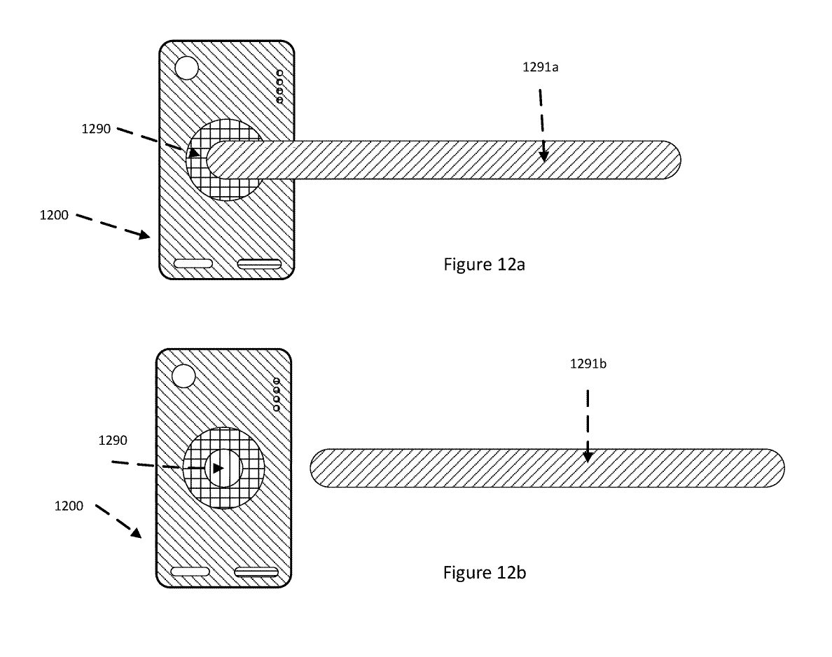

FIGS. 12a and 12b are behind views showing additional embodiments of the case with an accessory. FIG. 12a shows the external structure 1291a coupled to the device 1290 and FIG. 12b shows the external structure 1291b decoupled from the device 1200. The external device to be coupled to the present invention 1200 may be of any type or size and may be for any use and plurality. It may be a device such as a selfie stick as exampled in FIG. 12a or 12b, or may be of a different shape such as a stand, tripod, and standardized adapter such as to connect through the ¼-20 UNC adapter. Also, the device may have other uses of which one skilled in the art would intend such as a keyboard or motion capture device.

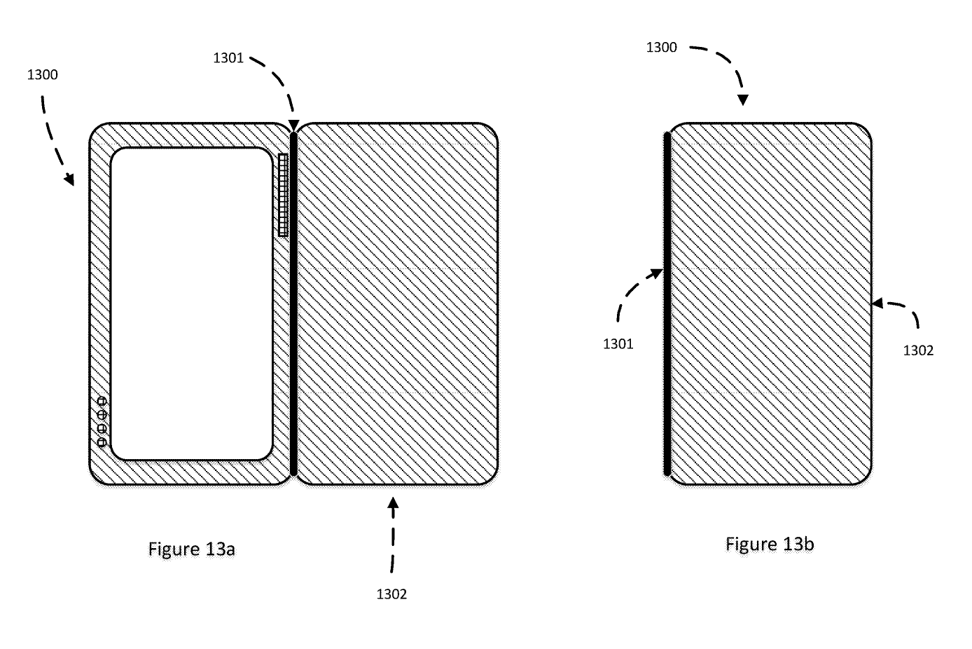

FIGS. 13a and 13b are frontal views of embodiments of the case in different configurations. FIG. 13a shows the present invention 1300 coupled to an external device 1302, of which may be a case cover or other device such as a keyboard, second display, touchpad, or any other device that one skilled in the art or the device use deems to be necessary. The external device 1302 is coupled to the present invention 1300 using coupling 1301. Coupling 1301 may be a permanent hinge or other coupling or may have the ability to be decoupled. The coupling 1301 may be of any type and may use mechanisms such as button releases, or may be a friction fit or other design. FIG. 13b shows the ability for the coupling to act like a hinge, to close the cover or external device over the front of the case and encased device to aide in other uses such as forming a protective cover, or providing another surface.

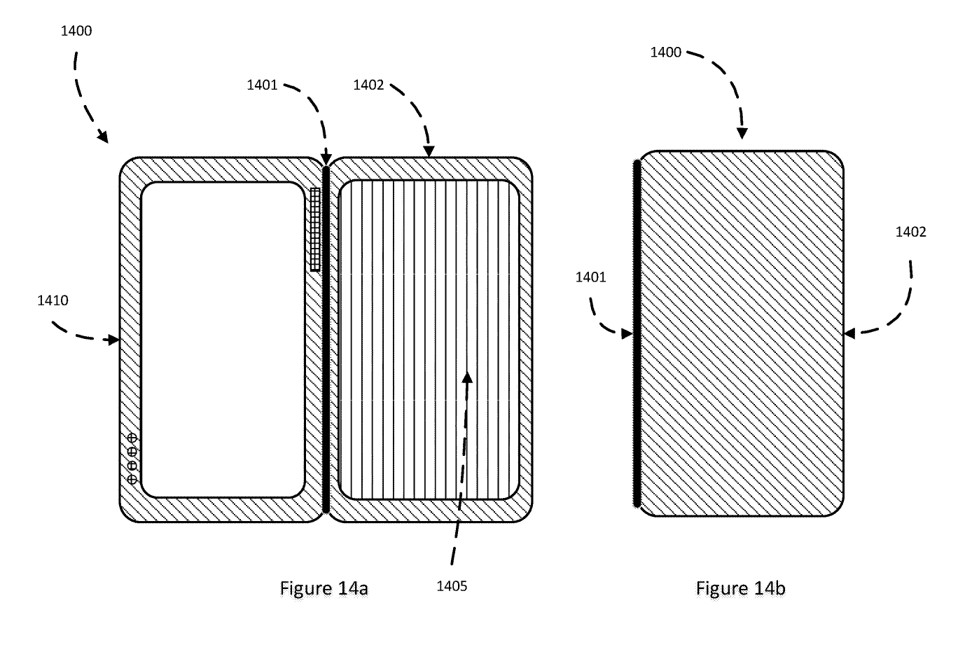

FIGS. 14a and 14b are frontal views of embodiments of the case in different configurations. FIG. 14a teaches a view of an embodiment of the case 1410 with an external device 1402 connected at the coupling 1401, similar to as seen in FIGS. 13a and 13b. The external deice 1402 may have an input such as a device 1405 such as a keyboard. Device 1405 may also be of any other device necessitated by the function of the present invention and may be a human interface device, display, or any other structure. FIG. 14b shows an embodiment with the device 1402 closed using coupling 1401.

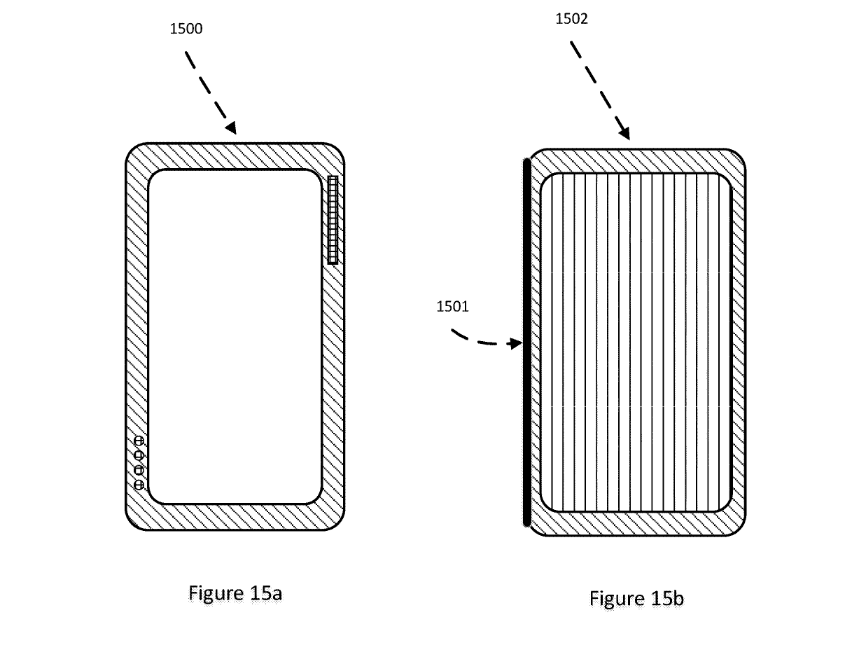

FIGS. 15a and 15b are frontal views of embodiments of the case in different configurations. FIG. 15a shows the case 1500 and FIG. 15b shows the external device 1502 with coupling 1501 unattached from the device 1500 teaching that the two may be separable.

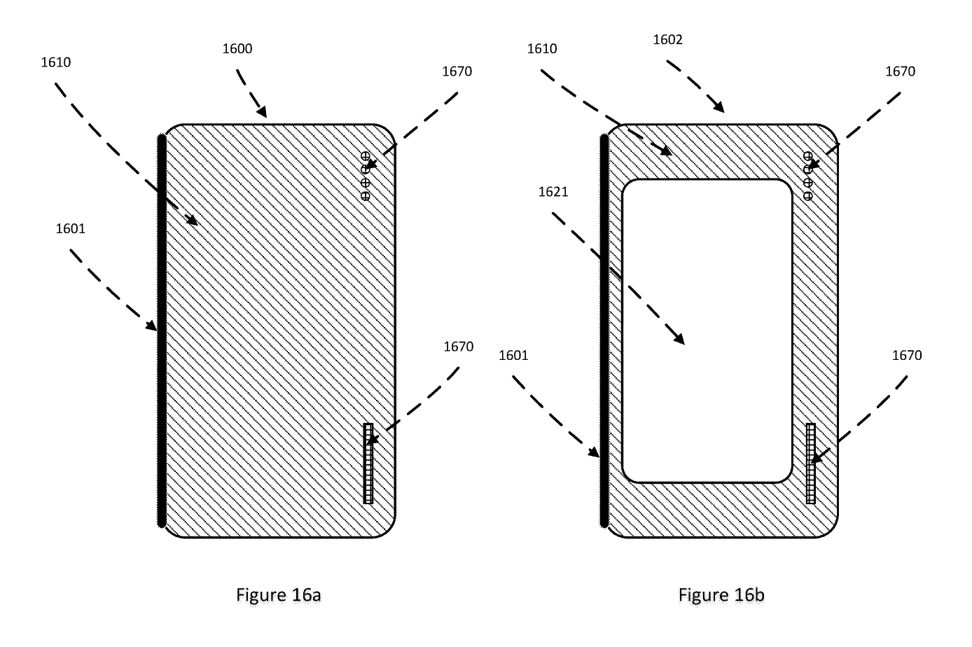

FIGS. 16a and 16b are frontal views of embodiments of the case in different configurations. FIG. 16a shows a front view of the external device 1610 coupled to the present invention case 1600 using coupling 1601. In this embodiment it is taught that the device 1610, may have sensors or emitters 1670 on the exterior to display information or other characteristics while the device is closed. The sensors or emitters 1670 may be of any size, location, disposition or plurality for any purpose and of any structure or method. FIG. 16b shows another embodiment of the front cover 1610 with the aforementioned features and structures but also with a cavity 1621 of which may be of any size, location, disposition for any use. Cavity 1621 may also house a window, or other transparent material of which either through lack of material, or through the material the display of the encased device is viewable, or manipulatable.

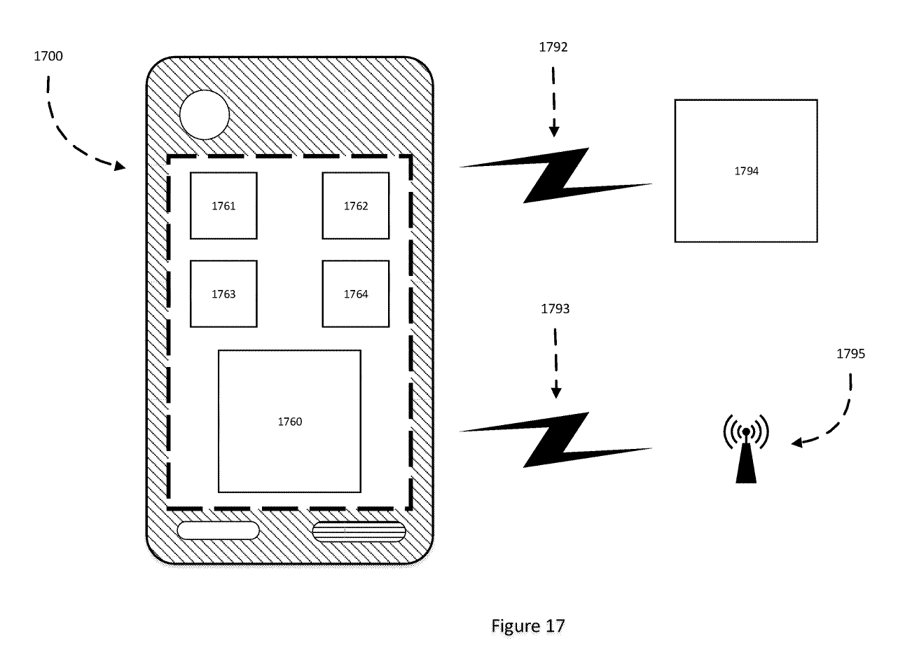

FIG. 17 is a frontal view of an embodiment of the case with a cutout demonstrating internal features and a systemic outline of connection. In FIG. 17 it is shown that the case 1700 may connect to a power source 1794 through method 1792 of which may be a wired power transfer between power source 1794 and the device 1700 in either direction or method. Also, the device 1700 may connect to wireless power source 1795 through wireless power connection 1793 and of which may transfer power in any direction. Wired method 1792 may use any form or gauge of wiring, such as power over a USB bus or through a designated DC power supply, and may include an inverter in the wire, in the case or in the power supply to convert AC to DV or vice versa, as well as other methods. Method 1793 may transfer power through any medium such as induction or any other wireless power method. The power may be directly passed through the case to the encased device or also simultaneously or solely used within the processes within 1761, 1762, 1763, or 1764 or also transferred into the battery 1760 either solely or simultaneously.

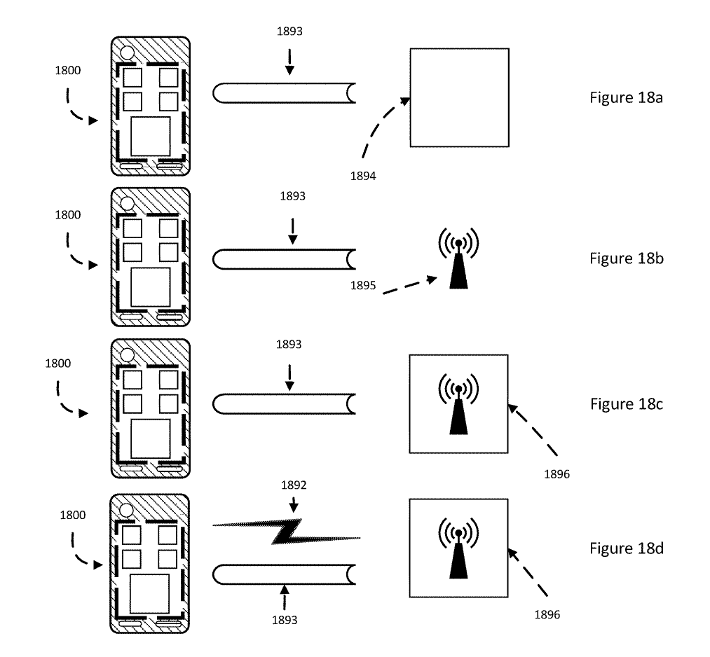

FIGS. 18a, 18b, 18c, and 18d are frontal views of embodiments of the case with a cutout demonstrating internal features and a systemic outline of connections. FIG. 18a shows encased device and device 1800 with data connection 1893 connect to device or network. The data connection 1893 can be wired and can be of any method or type such as USB or other any other connection method. The data connection can be in either direction and can pass through from the case to the encased device, or can be connected to processes within the case. FIG. 18b shows a similar embodiment to FIG. 18a, but displays a wireless data connection 1893 and wireless device or network 1895, of which may use any standard strength or method. FIG. 18c shows a similar embodiment to FIGS. 18b and 18a, but displays a data connection 1893 which may be wired or wireless connected to a wired device or wireless device 1896 of which also may be simultaneously connected and sending and receiving data simultaneously through wired and wireless methods. FIG. 18d is a similar embodiment to FIGS. 18a, 18b, and 18c but teaches to the ability to have both a power and data connection of which may be used solely or simultaneously connected to a wired or wireless data or power source or network 1896 of which may be separate devices, or single devices. The data and/or power may be served directly to the case and processes, or as a pass through to the device.

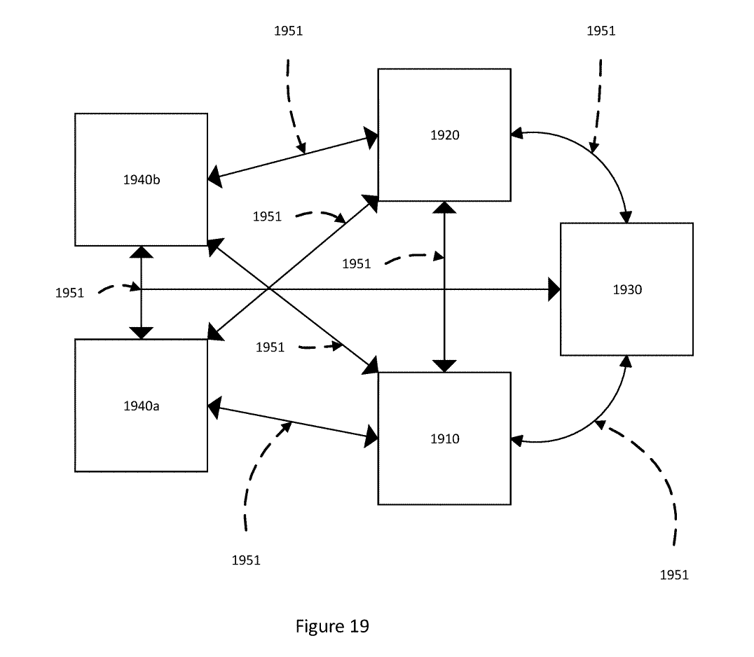

FIG. 19 is a systemic outline of an embodiment of the Present Invention and connections. Connections 1951 may be data or power connections, of which may be wired or wirelessor both simultaneously, may be used in either direction, may use any method, and be of any bandwidth and distance. 1930 may represent a power or data source, of which also may be a network, bus or one or multiple other devices or sources. 1910 may be the present invention case of which may accept power or data, 1920 may be the encased device which may accept power or data. 1940a and 1940b may be external devices which accept power or data from 1910 case or 1920 device or directly from the source. 1940a and 1940b may be external devices connected to the case or encased device or to the source 1930 directly of which may accept connections for data and power. It is noted that all connections, whether pass-through, wireless, wired or other methods may be made or acknowledged in any coronation or method between the present invention, the case, an overarching network or power-source, and other devices whether connected to the case or the present invention.

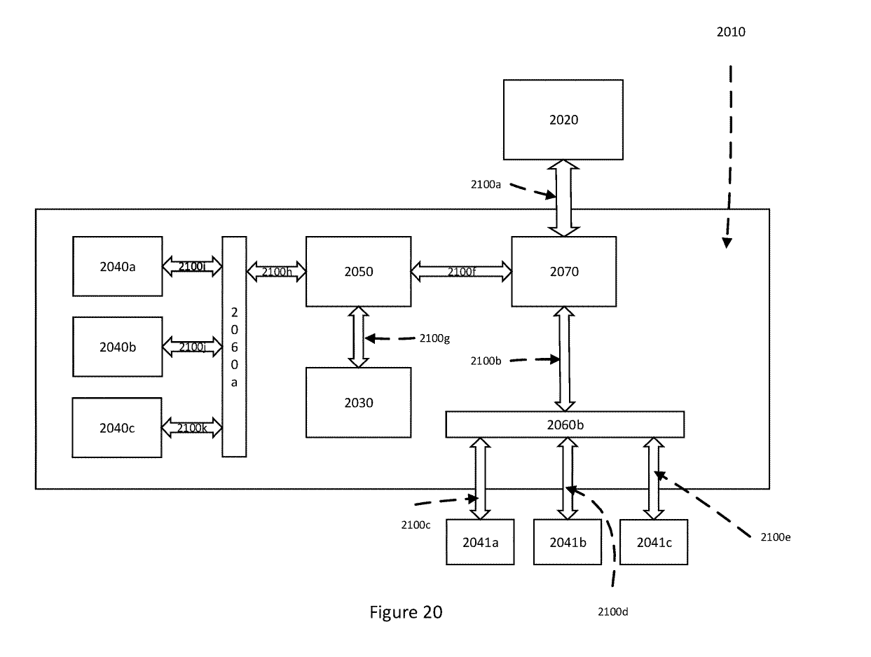

FIG. 20 is a systemic outline of an embodiment of the case with connections, internal processing and arrays. The FIG. 20a shows a referred embodiment of the internal structures of the present invention 2010. 2020 may be the encased device of which is connected to the case 2010 through process 2100a of which may be wired or wireless. Internally 2100a may be connected to a communication device of hub 2070 of which through process 2100b may be connection to an external peripheral bus 2060b which may then through process 2100c, 2100d, 2100e may be connected to emitters or sensors 2041a, hosts 2041b, or external devices such as a network or other devices 2041c. The communication hub may also be connected through connection 2100f to a processors of which may store memory through connection or method 2100g to memory bank 2030 of which may be of any type or size. The processer 2050 may then through connection 2100h be connection to a local internal bus 2060a of which through connection 2100i, 2100j and 2100k may be connection to sensors or emitters 2040a, devices 2040b, or structures 2040c of which can be of any type or method. This embodiment is merely the preferred embodiment and other embodiments may have different structures, connections and methods of which one skilled in the art would find to be of use. The connections aforementioned may be of any type or size, whether wireless or wired and may be to standards such as USB C, Bluetooth 4.0 Wi-Fi AC, etc.

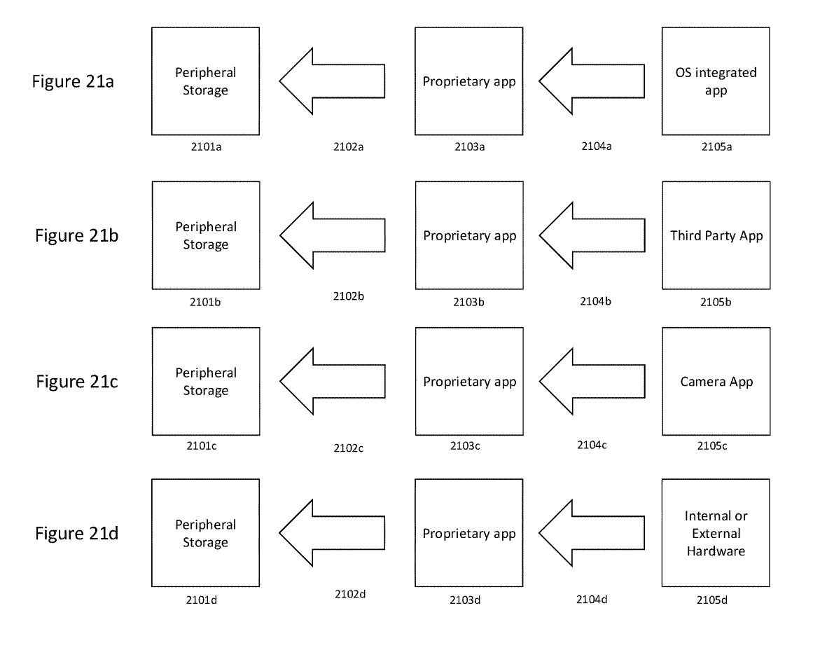

FIGS. 21a, 21b, 21c and 21d are systemic outlines of an embodiment of the case and the interactions with hardware and software.

FIG. 21a teaches towards an OS integrated app 2105a, such as a stock camera app or other type of data capturing application that then uses an action 2104a that may capture or send the data to the proprietary app 2103a, which may edit, pass through or otherwise manipulate the data, and then, through action 2102a, may write, save or otherwise store or manipulate the data in a peripheral storage 2101a of which may be a storage bank on the case, in the encased device, in a memory card or other storage device inserted into the case or encased device, or any other storage device, such as a networked device connected to the case or encased device.

FIG. 21b teaches towards an third party application 2105b, such as a third party camera app or other type of data capturing application that then uses an action 2104b that may capture or send the data to the proprietary app 2103b, which may edit, pass through or otherwise manipulate the data, and then, through action 2102b, may write, save or otherwise store or manipulate the data in a peripheral storage 2101b of which may be a storage bank on the case, in the encased device, in a memory card or other storage device inserted into the case or encased device, or any other storage device, such as a networked device connected to the case or encased device.

FIG. 21c teaches towards a dedicated camera application 2105c, such as a OS or third party camera app or other type of data capturing application that then uses an action 2104c that may capture or send the data to the proprietary app 2103c, which may edit, pass through or otherwise manipulate the data, and then, through action 2102c, may write, save or otherwise store or manipulate the data in a peripheral storage 2101c of which may be a storage bank on the case, in the encased device, in a memory card or other storage device inserted into the case or encased device, or any other storage device, such as a networked device connected to the case or encased device.

FIG. 21d teaches towards internal or external hardware 2105d which may be a case, encased device, network etc., such as a camera, Bluetooth or networked camera, or any other device or service which may provide or capture data that then uses an action 2104d that may capture or send the data to the proprietary app 2103d, which may edit, pass through or otherwise manipulate the data, and then, through action 2102d, may write, save or otherwise store or manipulate the data in a peripheral storage 2101d of which may be a storage bank on the case, in the encased device, in a memory card or other storage device inserted into the case or encased device, or any other storage device, such as a networked device connected to the case or encased device.

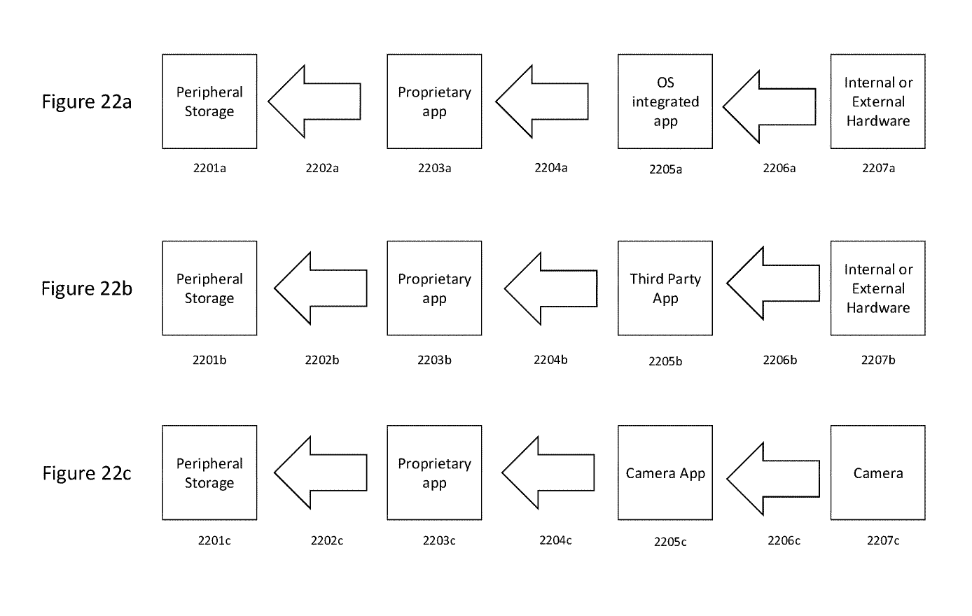

FIGS. 22a, 22b and 22c are systemic outlines of an embodiment of the case and the interactions with hardware and software.

FIG. 22a teaches towards an internal or external hardware such as a camera in the case, in the incased device, externally connected, networked, wirelessly connected or networked or of any form able to provide an action 2206a of which sends or captures data into an OS integrated app, such as a OS camera or photo editing app 2205a of which may use action 2204a to send or capture the data into the proprietary app 2203a of which may manipulate or edit or pass through the data and then use action 2202a of which sends, or writes a peripheral storage 2201a of which may be a storage bank on the case, in the encased device, in a memory card or other storage device inserted into the case or encased device, or any other storage device, such as a networked device connected to the case or encased device.

FIG. 22b teaches towards an internal or external hardware such as a camera in the case, in the incased device, externally connected, networked, wirelessly connected or networked or of any form able to provide an action 2206b of which sends or captures data into a third party app, such as a third party camera or photo editing app 2205b of which may use action 2204b to send or capture the data into the proprietary app 2203b of which may manipulate or edit or pass through the data and then use action 2202b of which sends, or writes a peripheral storage 2201b of which may be a storage bank on the case, in the encased device, in a memory card or other storage device inserted into the case or encased device, or any other storage device, such as a networked device connected to the case or encased device.

FIG. 22c teaches towards an internal or external hardware such as a camera in the case, in the incased device, externally connected, networked, wirelessly connected or networked or of any form able to provide an action 2206c of which sends or captures data into an OS integrated app, such as a OS camera or photo editing app 2205c of which may use action 2204c to send or capture the data into the proprietary app 2203c of which may manipulate or edit or pass through the data and then use action 2202c of which sends, or writes a peripheral storage 2201c of which may be a storage bank on the case, in the encased device, in a memory card or other storage device inserted into the case or encased device, or any other storage device, such as a networked device connected to the case or encased device.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied, and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A system for the encasement of a device, wherein the encasement comprises
damage protection,
a barrier from exterior elements,
an auxiliary battery,
an auxiliary memory storage,
enhancing features such as sensors, and
a connection between the system and an encased device.

2. A system as in claim 1, wherein
the connection is wired, wireless or both.

3. A system as in claim 1, wherein
the connection is for power, data or both.

4. A system as in claim 1, wherein
the enhancing features are exterior sensors.

5. A system as in claim 1, wherein
the case connects the device to external hardware or input devices.

6. A system as in claim 1, wherein
a software is installed on the encased device upon encasement.

7. A system as in claim 6, wherein
the software installs and executes automatically with limited user input.

8. A system as in claim 6, wherein
the software is installed from the auxiliary memory storage

9. A system as in claim 6, wherein
the software is downloaded and installed from the internet or network.

10. A system as in claim 6, wherein
the software is open source

11. A system as in claim 1, wherein
a file management system on the encased device reads and writes on the auxiliary memory storage directly.

12. A system as in claim 1, wherein
the memory storage on the encased device or the auxiliary memory storage is encrypted.

13. A system as in claim 1, wherein
the encasement comprises a processor and processing system.

14. A system as in claim 13, wherein
the processor and system works in conjunction with a processor and processing system in the encased device

15. A system as in claim 13, wherein
the processor and processing system works independently of the encased device processor and processing system.

16. A system for the encasement of a device, wherein the encasement encases a device and comprises
damage protection,
a barrier from exterior elements,
an auxiliary battery,
an auxiliary memory storage,
one or more enhancing features such as sensors,
a wireless or wired power or data connection between the system and the encased device, and
installs a software on the encased device upon encasement, wherein
the software installs and executes automatically
the software is installed from a factory installation on the auxiliary memory storage,
the software includes
a file management system on the encased device reads and writes on the auxiliary memory storage directly.

17. A system as in claim 16, wherein
the software is downloaded from the internet or network.

18. A system as in claim 16, wherein
the encasement comprises a processor and processing system.

19. A system as in claim 18, wherein
the processor and processing system works in conjunction with the encased device processor and processing system.

20. A system as in claim 18 wherein
the processor and processing system works independently of the encased device processor.
